(19) United States
(12) Patent Application Publication
(10) Pub. No.: US 2023/0254702 A1
(43) Pub. Date: Aug. 10, 2023

(54) SHARED SPECTRUM RESOURCE ALLOCATION IN OPEN RADIO ACCESS NETWORKS

(71) Applicant: QUALCOMM Incorporated, San Diego, CA (US)

(72) Inventors: Aleksandar DAMNJANOVIC, Del Mar, CA (US); Abhishek Saurabh SACHIDANAND SINHA, San Diego, CA (US); Rajat PRAKASH, San Diego, CA (US)

(21) Appl. No.: 17/650,197

(22) Filed: Feb. 7, 2022

(51) Int. Cl. H04W 16/14; H04W 16/10; H04W 28/08; H04W 28/26

(52) U.S. Cl. CPC H04W 16/14; H04W 16/10; H04W 28/0967; H04W 28/0846; H04W 28/26

(57) ABSTRACT

Wireless communications systems and methods related to communicating control information are provided. A method of wireless communication performed by a wireless node may include receiving, from a network node of a first network operator, a first consideration for shared spectrum resources, receiving, from a network node of a second network operator, a second consideration for the shared spectrum resources, and transmitting an indication of a resource allocation to at least one of the network node of the first network operator or the network node of the second network operator. The resource allocation for the shared spectrum resources may be based on the first consideration and the second consideration.

### TECHNICAL FIELD

This application relates to wireless communication systems, and more particularly, to shared spectrum resource allocation in open radio access networks.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

Multiple network operators may operate different networks in a same geographic area using separate resources. For example, a first network operator may operate in a first area using a first set of resources and a second network operator may operate in the first area using a second set of resources, such that both network operators may concurrently provide communications between base stations and UEs associated with the respective network. In some aspects, one network may experience congestion while the other network may have available resources and thus the resources may be used less efficiently than desired.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a wireless node may include receiving, from a network node of a first network operator, a first consideration for shared spectrum resources; receiving, from a network node of a second network operator, a second consideration for the shared spectrum resources; and transmitting an indication of a resource allocation to at least one of the network node of the first network operator or the network node of the second network operator. The resource allocation for the shared spectrum resources may be based on the first consideration and the second consideration.

In an additional aspect of the disclosure, a method of wireless communication performed by a network node of a first network operator may include transmitting, to a wireless node, a first consideration for shared spectrum resources; and receiving, from the wireless node, an indication of a resource allocation associated with the shared spectrum resources. The resource allocation may be based on the first consideration for shared spectrum resources and a second consideration for the shared spectrum resources associated with a second network operator.

In an additional aspect of the disclosure, an apparatus for wireless communications at a radio unit (RU), may include a processor; memory coupled with the processor; and instructions stored in the memory and executable by the processor to cause the apparatus to receive, from a network node of a first network operator, a first consideration for shared spectrum resources; receive, from a network node of a second network operator, a second consideration for the shared spectrum resources; and transmit an indication of a resource allocation to at least one of the network node of the first network operator or the network node of the second network operator. The resource allocation for the shared spectrum resources may be based on the first consideration and the second consideration.

In an additional aspect of the disclosure, an apparatus for wireless communications at a distributed unit (DU) may include a processor; memory coupled with the processor; and instructions stored in the memory and executable by the processor to cause the apparatus to transmit, to a wireless node, a first consideration for shared spectrum resources; and receive, from the wireless node, an indication of a resource allocation associated with the shared spectrum resources. The resource allocation may be based on the first consideration for shared spectrum resources and a second consideration for the shared spectrum resources associated with a second network operator.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2A illustrates an example disaggregated base station architecture according to some aspects of the present disclosure

FIG. 2B illustrates a wireless communication network using shared resources according to some aspects of the present disclosure.

FIG. 3 illustrates an example of an RU sharing network according to some aspects of the present disclosure.

FIG. 4 illustrates shared resources in an open radio access network according to some aspects of the present disclosure.

FIG. 5 is a signaling diagram of a wireless communication method according to some aspects of the present disclosure.

FIG. 6 is a signaling diagram of a wireless communication method according to some aspects of the present disclosure.

FIG. 7 is a block diagram of an exemplary user equipment (UE) according to some aspects of the present disclosure.

FIG. 8 is a block diagram of an exemplary base station (BS) according to some aspects of the present disclosure.

FIG. 9 is a block diagram of an exemplary distributed unit (DU) and an exemplary radio unit (RU) according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNIT) radio band has a minimum OCB requirement of about 70 percent (%).

Some sidelink systems may operate over a 20 MHz bandwidth in an unlicensed band. ABS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

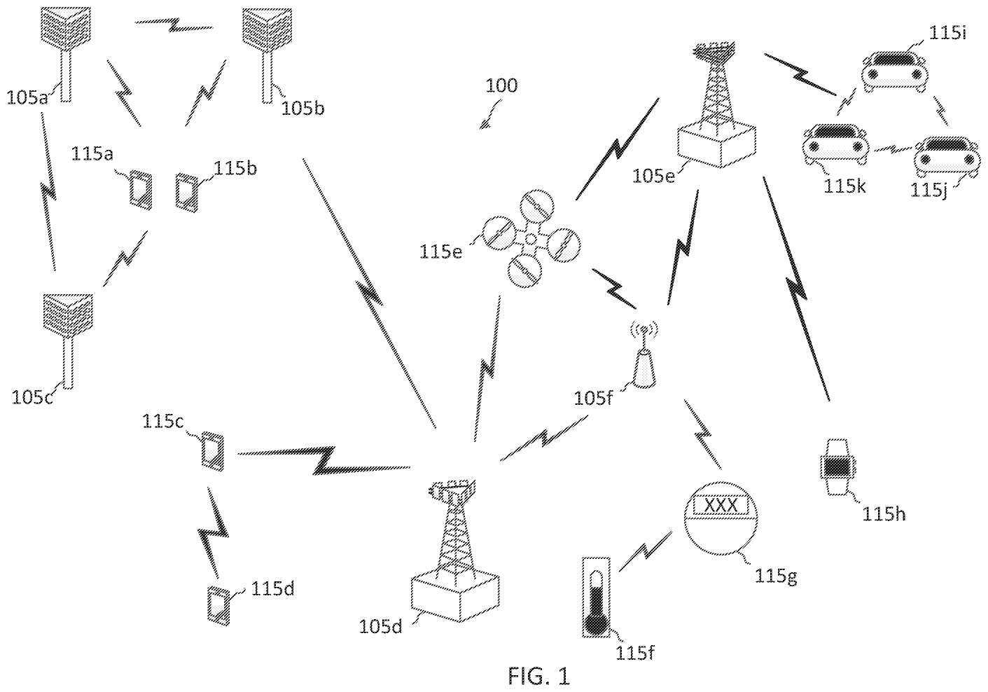

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V21) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

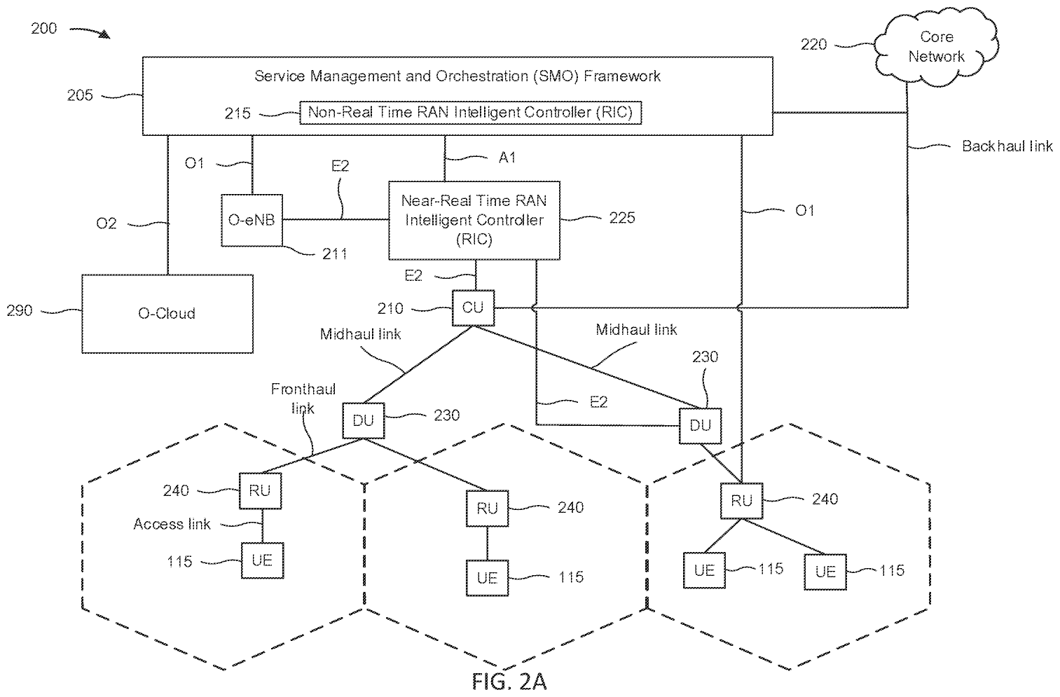

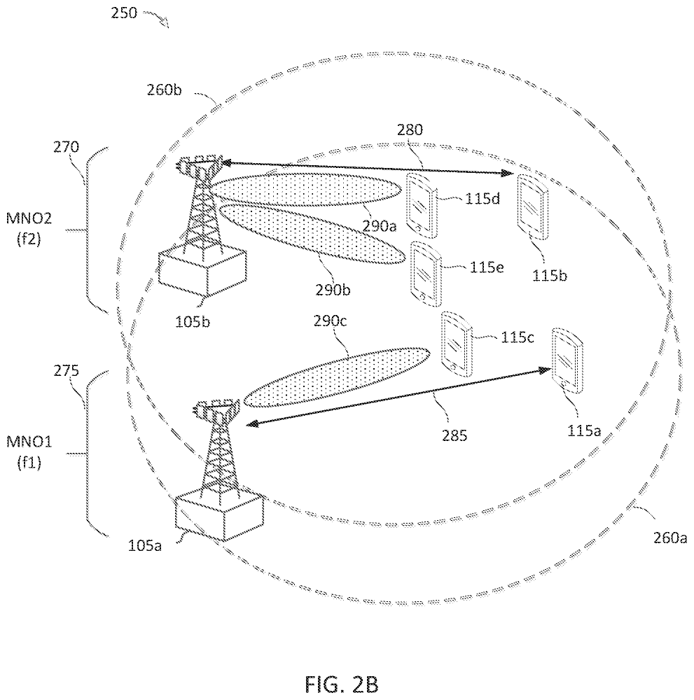

FIG. 2A shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT MC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

FIG. 2B illustrates an example of a wireless communications network 250 that supports RU and spectrum sharing techniques in wireless communications according to some aspects of the present disclosure. In some aspects, the wireless communications network 250 may implement aspects of wireless communications network 100. Wireless communications network 250 may include a first base station 105a and a second base station 105b that may be examples of base stations 105 as described with respect to FIG. 1. The wireless communications network 250 may also include UEs 115a, 115b, 115c, 115d, and 115e that may be examples of UEs 115 as described with respect to FIG. 1. In this example, the first base station 105a and UEs 115a and 115c may be associated with a first MNO 275 (MNO1), and may communicate using first communication link 285 and/or a first directional beam 290c that uses a first frequency (f1) range. Likewise, the second base station 105b and UEs 115b, 115e, and 115d may be associated with a second MNO 270 (MNO2), and may communicate using second communication link 280 and/or direction beams 290a and/or 290b that uses a second frequency (f2) range.

In cases where each of the first MNO 275 and the second MNO 270 exclusively use their own dedicated resources, the first MNO 275 may in some time periods have unused time/frequency/beam resources while the second MNO 270 has more data to transfer than can be accommodated by its dedicated resources in the time period. Further, one or more UEs 115 that are served by the second MNO 270 (e.g., the UEs 115b, 115d, 115e) may be within a first coverage area 260a of the first base station 105a as well as within a second coverage area 260b of the second base station. In accordance with various techniques discussed herein, in some cases a network node of the second MNO 270 (e.g., a DU) may request resources of the first MNO 275 (e.g., the first base station 105a or an associated RU).

In some aspects, one or more RUs may be owned and operated by a site owner (e.g., MNO1 or MNO2) and the site owner may also own the spectrum (e.g., f1 or f2) for communications in the relevant geographical area (e.g., first coverage area 260a or second coverage area 260b) such that each MNO may desire to access to the site owner's RUs and/or spectrum. In such cases, one or more of the MNOs may not have purchased the spectrum, but may lease the spectrum from the site/spectrum owner. In other cases, one or more MNOs may own one or more shared RUs and/or an associated portion of the spectrum (e.g., a set of frequencies (f1 or f2) on which the MNO may have ownership and/or priority over all other operators). In some instances, priority among the non-spectrum owning MNOs for access to the RUs and/or spectrum may be based on various factors, such as consideration offered for the time/frequency/beam resources, fee payment, reciprocal priority sharing, etc. In some aspects, government regulators and/or spectrum managers may influence RU sharing through policy and/or conditions when spectrum is shared. In some aspects, each DU may transmit a request and associated consideration for shared resources to one or more RUs. The one or more RUs may determine the resource allocation based at least on the consideration for each DU and provide an indication (e.g., a resource allocation) back to the DU indicating the resources that are allocated to the DU.

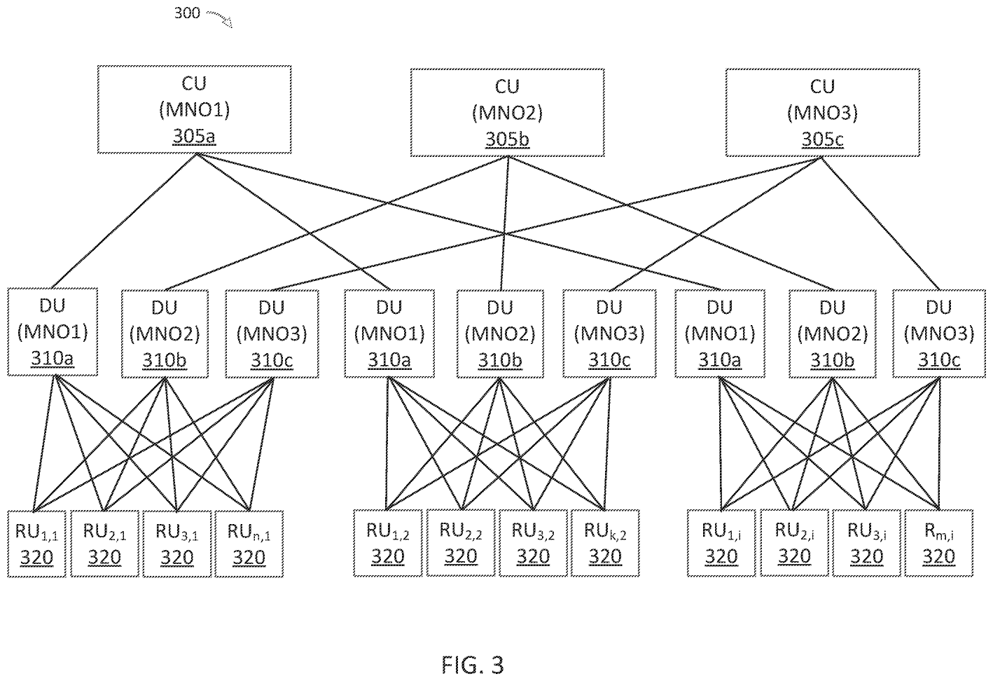

FIG. 3 illustrates an example of an RU sharing network architecture 300 that supports RU and time/frequency/beam sharing techniques in wireless communications according to some aspects of the present disclosure. In some aspects, the RU sharing network architecture 300 may implement aspects of wireless communications network 100, 200, or 250. In the example of FIG. 3, multiple centralized units (CUs) 305 (e.g., CU 210) associated with different MNOs may be interconnected with multiple associated distributed units (DUs) 310 (e.g. DU 230). In this example, a first CU 305-a may be associated with a first MNO and interconnected with multiple associated DUs 310-a of the first MNO. Likewise, second CU 305-b and third CU 305-c may be associated with a second MNO and third MNO, respectively, and interconnected with corresponding DUs 310-b and 310-c. A number of RUs 320 (e.g., RU 230) may be shared among all of the MNOs. In some aspects, each RU 320 may be interconnected with a DU 310 of each MNO. Thus, multiple DUs 310 belonging to different MNOs may be connected to a common, shared RU 320. Each RU 320 may be configured to transmit and/or receive (e.g., via one or multiple antennas) on different frequencies, such that spectrum associated with each MNO (e.g., f1 for MNO1, f2 for MNO2, and f3 for MNO3) is accessible via the RUs 320.

In some aspects, one or multiple RUs 320 may be owned and operated by a site owner that may also own the spectrum for communications, and thus each MNO may have access to the site owners RUs 320 and spectrum. In such examples, the MNOs may not have purchased the spectrum, but may lease the spectrum from the site/spectrum owner. In other cases, one or more operators (e.g., each MNO) may own one or more shared RU 320 and an associated portion of the spectrum on which the MNO that owns the spectrum has priority over all other operators and where priority among the non-owning MNOs may be based on other factors, such as consideration for the time/frequency/beam resources, fee payment, reciprocal priority sharing, etc. In some aspects, each DU 310 may transmit a request and associated consideration for time/frequency/beam resources to one or more RUs 320. The one or more RUs 320 may allocate the resources for each DU 310 based at least on the consideration and provide an indication (e.g., a resource allocation) back to the DU 310 indicating the resources that are allocated to the DU 310.

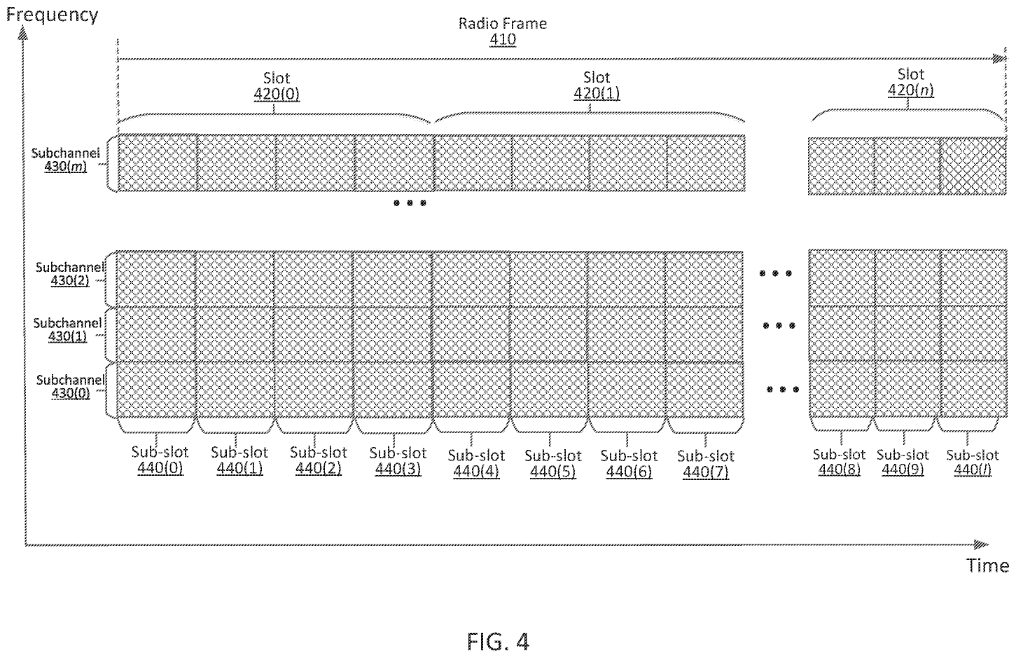

FIG. 4 illustrates shared resources in an open radio access network according to some aspects of the present disclosure. In FIG. 4, the x-axis represents time in some arbitrary units. The x-axis represents frequency in some arbitrary units. The shared spectrum resources may refer to a combination of radio frequency resource(s), time resource(s), and/or spatial resource(s) (e.g., spatial layers or beam directions). In some aspects, the time resources may include time intervals of a communications resource organized according to radio frames 410 each having a specified duration (e.g., 10 milliseconds (ms)). Each radio frame 410 may be identified by a system frame number (SFN) (e.g., ranging from 0 to 1023). Each radio frame 410 may include multiple consecutively numbered subframes or slots 420. Each subframe or slot 420 may have the same or different duration (e.g., 1 ms). In some aspects, a radio frame 410 may be divided in the time domain into subframes, and each subframe may be further divided into a number of slots 420. Additionally or alternatively, each radio frame 410 may include a variable number of slots 420 and the number of slots 420 may depend on a frequency subcarrier 430 spacing. Each slot 420 may include a number of symbol periods (e.g., depending on the length of the cyclic prefix associated with each symbol period). In some aspects, a slot 420 may further be divided into multiple mini-slots 440 containing one or more symbols. The duration of a symbol period may depend on the subcarrier spacing or frequency band of operation. In some aspects, a subframe, a slot 420, a mini-slot 440, or a symbol may be the smallest time resource unit in the time domain (e.g., a transmission time interval (TTI)) of the shared spectrum resource allocation. In some aspects, the TTI duration (e.g., the number of symbol periods in a TTI) may be variable. Additionally or alternatively, the smallest time resource unit of the resource allocation may be dynamically selected (e.g., selected in bursts of shortened TTIs).

In some aspects, the shared spectrum resources may include one or more frequency bands. The frequency bands may include any frequency range. For example, the frequency bands may include a subchannel 430, a subcarrier, a frequency carrier, a frequency spectrum, a bandwidth, a bandwidth part, or any suitable frequency band. In some aspects, the frequency band in the shared spectrum resources may include a licensed and/or an unlicensed frequency band.

The frequency band may be operated according to one or more physical layer channels for a given radio access technology (e.g., E-UTRA, LTE, LTE-A, LTE-A Pro, NR, WiFi, sidelink, etc.). In some aspects, the frequency band may be one of a number of determined bandwidths for carriers of a particular radio access technology (e.g., 1.4, 3, 5, 10, 15, 20, 40, or 80 megahertz (MHz)). The frequency bands may be allocated as a single (e.g., continuous) frequency band and/or multiple frequency bands (e.g., subchannels 430). The multiple frequency bands may be continuous and/or separate frequency bands. In some aspects, the multiple frequency bands may include a set of interlaced frequency resources. The interlaced frequency resources may configured with a number of frequency interlaces in the frequency band, an interlace-spacing (e.g., the frequency separation among interlaced frequency resources within a frequency interlace), and/or a frequency interlace size (e.g., the number of interlaced frequency resources within a frequency interlace). The frequency band may be configured with frequency interlaces of equal sizes in a frequency band. In some instances, a frequency band may be configured with frequency interlaces of multiple sizes. Devices of the wireless communications network 100, 200, or 250 (e.g., the base stations 105, the UEs 115, the DUs 905, and/or the RUs 955) may have hardware configurations that support communications over a particular carrier bandwidth or may be configurable to support communications over one of a set of frequency bands. In some aspects, the wireless communications network 100, 200, or 250 may support simultaneous communications via carriers associated with multiple frequency bands. The wireless communications network 100, 200, or 250 may be configured for operating over portions (e.g., a sub-band, a BWP) or all of a frequency band.

In some aspects, an RU (e.g., the RU 955) may receive a first consideration and a second consideration for partially overlapping time resources. For example, the first MNO may transmit a request and associated first consideration to the RU for shared spectrum resources including slot indexes 420(0)-420(6), while the second MNO may transmit a request and associated second consideration to the RU for shared spectrum resources including slot indexes 420(4)-420(9). In this case, the RU may determine the resource allocation based on the highest of the first consideration and the second consideration for the overlapping resources in slot indexes 420(4)-420(6). If the first consideration is higher and/or better than the second consideration, then the RU may allocate slot indexes 420(0)-420(6) to the first MNO. The RU may allocate slot indexes 420(7)-420(9) to the second MNO based on the second MNO indicating that it will accept a partial allocation of the requested resources. In some aspects, the RU may allocate resources on a slot by slot basis. The RU may allocate resources to one MNO or multiple MNOs in time (e.g., multiple MNOs are allocated the same slot index 420), but are allocated separate frequency resources and/or separate spatial resources (e.g., separate beams). If the second consideration is higher and/or better than the first consideration, then the RU may allocate slot indexes 420(4)-420(9) to the second MNO. The RU may allocate slots 420(0)-420(3) to the first MNO based on the first MNO indicating that it will accept a partial allocation of the requested resources. The allocation of shared spectrum resources by the RU is not limited to the first and second MNOs. For example, the RU may also receive a third consideration from a third MNO for shared spectrum resources including slot indexes 420(4)-420(6). If the third consideration is higher and/or better than the first and second considerations, then the RU may allocate slot indexes 420(4)-420(6) to the third MNO. The RU may allocate slots 420(0)-420(3) to the first MNO based on the first MNO indicating that it will accept a partial allocation of the requested resources and allocate slots 420(7)-420(9) to the second MNO based on the second MNO indicating that it will accept a partial allocation of the requested resources.

In some aspects, the RU may receive the first consideration and the second consideration for non-overlapping (e.g., exclusive) time resources. For example, the first MNO may transmit a request and associated first consideration to the RU for shared spectrum resources including slot indexes 420(0)-420(4), while the second MNO may transmit a request and associated second consideration to the RU for shared spectrum resources including slot indexes 420(5)-420(9). In this case, since the first and second MNOs are not requesting any of the same time resources, the RU may allocate the requested slots 420(0)-420(4) to the first MNO and allocate the requested slots 420(5)-420(9) to the second MNO.

Although the examples above describe allocation of complete overlapping, partial overlapping, and non-overlapping shared spectrum resources on a time slot basis, the present disclosure is not so limited and the allocation of shared spectrum resources may be based on other time resources (e.g., radio frames, mini-slots 440, symbols, etc.).

In some aspects, the RU may receive the first consideration and the second consideration for partially overlapping frequency band resources. For example, the first MNO may transmit a request and associated first consideration to the RU for shared spectrum resources including subchannel indexes 430(0)-430(1), while the second MNO may transmit a request and associated second consideration to the RU for shared spectrum resources including subchannel indexes 430(1)-430(2). In this case, the RU may determine the resource allocation based on the highest of the first consideration and the second consideration for the overlapping resources in subchannel index 430(1). If the first consideration is higher and/or better than the second consideration, then the RU may allocate subchannel indexes 430(0)-430(1) to the first MNO. The RU may allocate subchannel index 430(2) to the second MNO based on the second MNO indicating that it will accept a partial allocation of the requested resources. If the second consideration is higher and/or better than the first consideration, then the RU may allocate subchannel indexes 430(1)-430(2) to the second MNO. The RU may allocate subchannel index 430(0) to the first MNO based on the first MNO indicating that it will accept a partial allocation of the requested resources. Again, the allocation of shared spectrum resources by the RU is not limited to the first and second MNOs. For example, the RU may also receive a third consideration from a third MNO for shared spectrum resources including subchannel indexes 430(1)-430(2). If the third consideration is higher than the first and second considerations, then the RU may allocate subchannel indexes 430(1)-430(2) to the third MNO. The RU may allocate subchannel index 430(0) to the first MNO based on the first MNO indicating that it will accept a partial allocation of the requested resources.

In some aspects, the RU may receive the first consideration and the second consideration for non-overlapping (e.g., exclusive) frequency resources. For example, the first MNO may transmit a request and associated first consideration to the RU for shared spectrum resources including subchannel index 430(0) while the second MNO may transmit a request and associated second consideration to the RU for shared spectrum resources including subchannel indexes 430(1)-430(2). In this case, since the first and second MNOs are not requesting any of the same frequency resources, the RU may allocate the requested subchannel 430(0) to the first MNO and allocate the requested subchannels 430(1)-430(2) to the second MNO. Although the examples above describe allocation of complete overlapping, partial overlapping, and non-overlapping shared spectrum resources on a subchannel basis, the present disclosure is not so limited and the allocation may be based on other frequency resources (e.g., frequency bands, frequency carriers, frequency spectrums, a bandwidth, a bandwidth part, etc.).

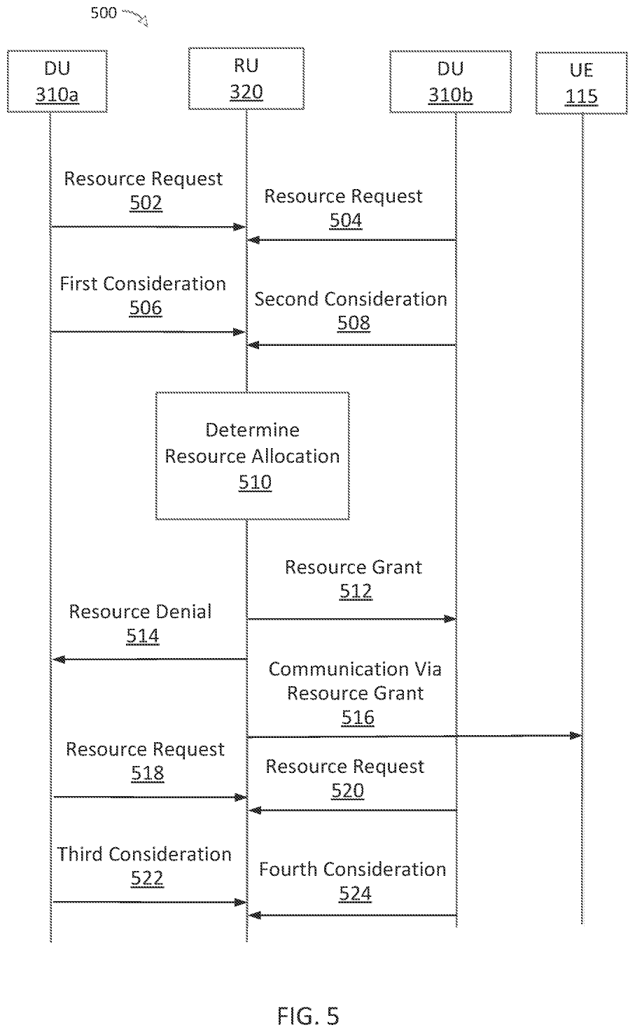

FIG. 5 is a signaling diagram of a communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115 or UE 700, may utilize one or more components, such as the processor 702, the memory 704, the resource allocation module 708, the transceiver 710, the modem 712, and the one or more antennas 716, to execute aspects of method 500. For example, a wireless communication device, such as the radio unit (RU) 955, may utilize one or more components to execute aspects of method 500. For example, a wireless communication device, such as a distributed unit (DU) 905, may utilize one or more components, such as network communications manager 910, communications manager 920, RU communications manager 945, memory 930, instructions 935, and processor 940 to execute aspects of the method 500.

At action 502, the DU 310a may transmit a resource request to the RU 320. The requested resources may be shared resources including time resources, frequency resources, and/or beam (e.g., spatial) resources.

At action 504, the DU 310b may transmit a resource request to the RU 320. The requested resources may be shared resources including time resources, frequency resources, and/or beam (e.g., spatial) resources.

At action 506, the DU 310a may transmit a first consideration to the RU320 for the resources requested at action 502.

At action 508, the DU 310b may transmit a second consideration to the RU320 for the resources requested at action 504. The DUs 310a and 310b may transmit the first and second considerations respectively for shared spectrum resources that completely overlap. In some aspects, the first consideration and/or the second consideration may include, without limitation, a token, a currency, a cryptocurrency, a digital currency, or a combination thereof. The token may include a digital token that represents an amount of digital resources and/or time/frequency resources. The digital token may be owned, assigned, redeemed, converted, and/or exchanged for other forms of consideration by the MNO. In some aspects, the currency may include any form or type of currency. For example, the currency may include money (e.g., dollars, Euros, Yen, etc.) in any form or circulation as a medium of consideration offering and/or exchange. The cryptocurrency (e.g., Bitcoin, Ethereum, etc.) may include any type and/or collection of data which is designed to work as a medium of consideration exchange. The cryptocurrency may be implemented with decentralized control through distributed ledger technology, such as a blockchain. The digital currency may include any currency, money, or asset that is managed, stored and/or exchanged on one or more digital computer systems.

At action 510, the RU 320 may determine a resource allocation for the resources requested at actions 502 and 504 based at least on the first and second considerations. The RU may determine the resource allocation based on the highest and/or better of the first consideration and the second consideration. If the first consideration is higher and/or better than the second consideration, then the RU may allocate some or all of the shared spectrum resources to the DU 310a. If the second consideration is higher and/or better than the first consideration, then the RU may allocate some or all of the shared spectrum resources to the DU 310b. The allocation of shared spectrum resources by the RU 320 may be based on consideration offers from any number of MNOs that may share the RU 320 and/or spectrum resources. For example, the RU 320 may also receive a third (a fourth, a fifth, etc.) consideration for the same shared spectrum resources. If the third (fourth, fifth, etc.) consideration is higher and/or better than the first and/or second considerations, then the RU 320 may allocate some or all of the shared spectrum resources to the third (fourth, fifth, etc.) DU. In some instances, when a requesting DU is not allocated the requested resources based on the offered consideration, then the DU may submit one or more additional considerations (e.g., increased consideration) for the requested resources based on the processing latency associated with determining the resource allocation at action 510 and/or the amount of time (e.g., amount of available time) between determining the resource allocation at action 512 and the beginning of the communication at action 516. The RU 320 may allocate the requested resources based on the increased consideration.

At action 512, the RU 320 may transmit a resource grant associated with the resource allocation to the DU 310b based on the second consideration being higher and/or better than the first consideration. The resource grant may indicate that the resources requested at action 504 are allocated to the DU 310b.

At action 514, the RU 320 may transmit a resource request denial to the DU 310a based on the second consideration being higher and/or better than the first consideration. The resource request denial may indicate that the resources requested at action 502 are not allocated to the DU 310a.

At action 516, the RU 320 may transmit and/or receive a communication via the resources granted at action 512 to the UE 115. The RU 320 may receive the communication from the DU 310b and transmit the communication to the UE 115. The RU 320 may receive the communication from the UE 115 and transmit the communication to the DU 310b. The communication may include a PDCCH, a PDSCH, a PUCCH, a PUSCH, or other suitable communication.

At action 518, the DU 310a may transmit another resource request to the RU 320. The requested resources may be different than the resources requested at action 502.

At action 520, the DU 310a may transmit another resource request to the RU 320. The requested resources may be different than the resources requested at action 504.

At action 522, the DU 310a may transmit a third consideration to the RU320 for the resources requested at action 518.

At action 524, the DU 310b may transmit a fourth consideration to the RU320 for the resources requested at action 520. The DUs 310a and 310b may transmit the third and fourth considerations respectively for shared spectrum resources.

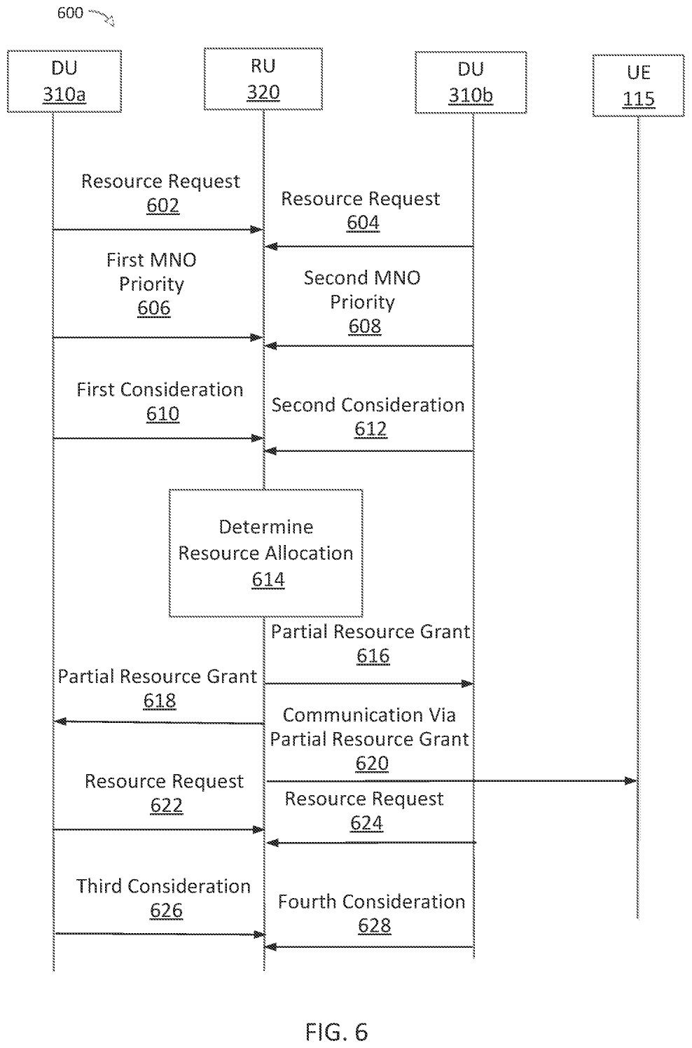

FIG. 6 is a signaling diagram of a communication method 600 according to some aspects of the present disclosure. Actions of the communication method 600 can be executed by a computing device (e.g., a processor, processing circuit, and/or other suitable component) of a communication device or other suitable means for performing the actions. For example, a wireless communication device, such as the UE 115 or UE 700, may utilize one or more components, such as the processor 702, the memory 704, the resource allocation module 708, the transceiver 710, the modem 712, and the one or more antennas 716, to execute aspects of method 600. For example, a wireless communication device, such as the radio unit (RU) 955, may utilize one or more components to execute aspects of method 600. For example, a wireless communication device, such as a distributed unit (DU) 905, may utilize one or more components, such as network communications manager 910, communications manager 920, RU communications manager 945, memory 930, instructions 935, and processor 940 to execute aspects of the method 600.

At action 602, the DU 310a may transmit a resource request to the RU 320. The requested resources may be shared resources including time resources, frequency resources, and/or beam resources.

At action 604, the DU 310b may transmit a resource request to the RU 320. The requested resources may be shared resources including time resources, frequency resources, and/or beam resources.

At action 606, the DU 310a may transmit an indicator to the RU 320 indicating a priority associated with the first MNO. The first MNO may have priority rights to the resources requested at action 602. In some aspects, the first MNO may own and/or operate the DU 310a.

At action 608, the DU 310a may transmit an indicator to the RU 320 indicating a priority associated with the second MNO. The second MNO may have priority rights to the resources requested at action 604. In some aspects, the second MNO may own and/or operate the DU 310b.

At action 610, the DU 310a may transmit a first consideration to the RU320 for the resources requested at action 602.

At action 612, the DU 310b may transmit a second consideration to the RU320 for the resources requested at action 604.

The DU 310a and 310b may transmit the first and second considerations respectively for shared spectrum resources that partially overlap. In some aspects, the first consideration and/or the second consideration may include, without limitation, a token, a currency, a cryptocurrency, a digital currency, or a combination thereof.

At action 614, the RU 320 may determine a resource allocation for the resources requested at actions 602 and 604 based at least on the first and second priorities and the first and second considerations. In some aspects, the shared RU 320 may receive requests for resources (e.g., fully overlapping resources or partially overlapping resources) from DU 310a and DU 310b for shared spectrum resources. The RU 320 may determine a resource allocation based on the priorities associated with the different MNOs that own and/or control the DU 310a and DU 310b. In some aspects, a DU 310a may have a higher priority than the DU 310b or a third DU. The resources may be allocated to the DU 310a ahead of the DU 310b or the third DU based on the higher priority of the DU 310a.

In some aspects, the RU 320 may receive the first consideration and the second consideration for partially overlapping time and/or frequency resources. The RU may determine the resource allocation based on the highest and/or better of the first consideration and the second consideration for the overlapping resources. If the first consideration is higher and/or better than the second consideration, then the RU 320 may allocate the overlapping resources to the DU 310a. The RU 320 may allocate the non-overlapping resources to the DU 310b based on the DU 310b indicating that it will accept a partial allocation of the requested resources. If the second consideration is higher than the first consideration, then the RU 320 may allocate the overlapping resources to the DU 310b and the non-overlapping resources to the DU 310a.

At action 616, the RU 320 may transmit a partial resource grant for the overlapping resources to the DU 310b based on the second consideration being higher and/or better than the first consideration.

At action 618, the RU 320 may transmit a partial resource grant for the non-overlapping resources to the DU 310a based on the second consideration being higher and/or better than the first consideration.

At action 620, the RU 320 may transmit and/or receive a communication via the resources granted at action 616 to the UE 115. The RU 320 may receive the communication from the DU 310b and transmit the communication to the UE 115. The RU 320 may receive the communication from the UE 115 and transmit the communication to the DU 310b. The communication may include a PDCCH, a PDSCH, a PUCCH, a PUSCH, or other suitable communication.

At action 622, the DU 310a may transmit another resource request to the RU 320. The requested resources may be different than the resources requested at action 602.

At action 624, the DU 310a may transmit another resource request to the RU 320. The requested resources may be different than the resources requested at action 604.

At action 626 the DU 310a may transmit a third consideration to the RU320 for the resources requested at action 622.

At action 628 the DU 310b may transmit a fourth consideration to the RU320 for the resources requested at action 624. The DU 310a and 310b may transmit the third and fourth considerations respectively for shared spectrum resources.

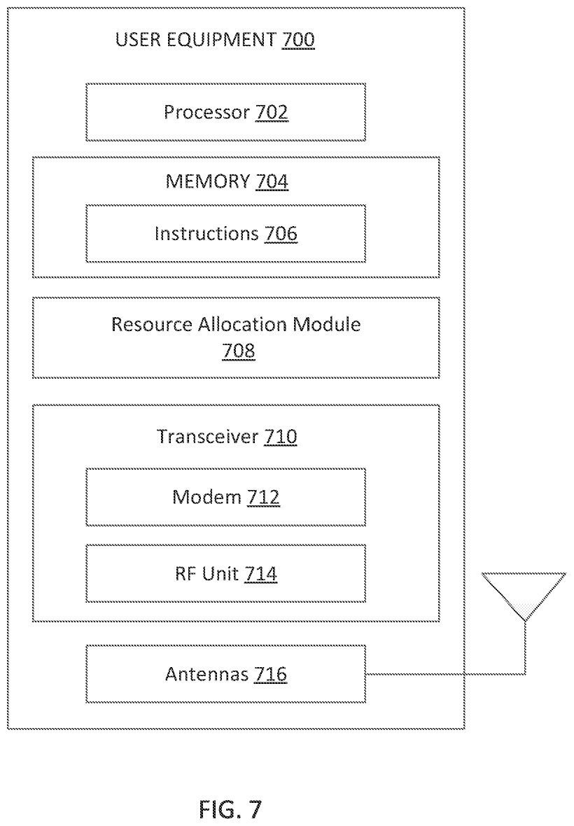

FIG. 7 is a block diagram of an exemplary UE 700 according to some aspects of the present disclosure. The UE 700 may be the UE 115 in the network 100, 200, or 250 as discussed above. As shown, the UE 700 may include a processor 702, a memory 704, a resource allocation module 708, a transceiver 710 including a modem subsystem 712 and a radio frequency (RF) unit 714, and one or more antennas 716. These elements may be coupled with each other and in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 704 includes a non-transitory computer-readable medium. The memory 704 may store instructions 706. The instructions 706 may include instructions that, when executed by the processor 702, cause the processor 702 to perform the operations described herein with reference to the UEs 115 in connection with aspects of the present disclosure, for example, aspects of FIGS. 2-6 and 10-11. Instructions 706 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The resource allocation module 708 may be implemented via hardware, software, or combinations thereof. For example, the resource allocation module 708 may be implemented as a processor, circuit, and/or instructions 706 stored in the memory 704 and executed by the processor 702. In some aspects, the resource allocation module 708 may be used to communicate to a RU (e.g., the RU 955) via shared spectrum resources.

As shown, the transceiver 710 may include the modem subsystem 712 and the RF unit 714. The transceiver 710 can be configured to communicate bi-directionally with other devices, such as the BSs 105 and/or the UEs 115. The modem subsystem 712 may be configured to modulate and/or encode the data from the memory 704 and the according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The antennas 716 may include multiple antennas of similar or different designs in order to sustain multiple transmission links. The RF unit 714 may configure the antennas 716.

In some instances, the UE 700 can include multiple transceivers 710 implementing different RATs (e.g., NR and LTE). In some instances, the UE 700 can include a single transceiver 710 implementing multiple RATs (e.g., NR and LTE). In some instances, the transceiver 710 can include various components, where different combinations of components can implement RATs.

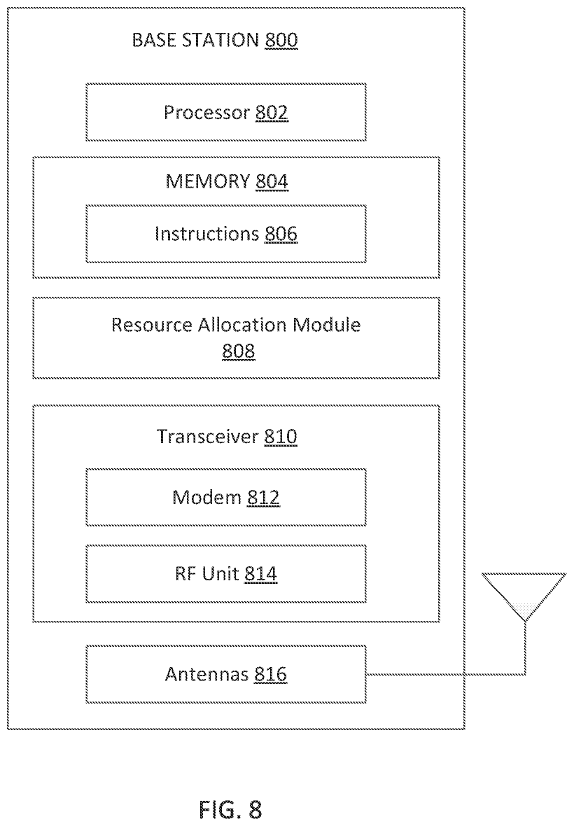

FIG. 8 is a block diagram of an exemplary BS 800 according to some aspects of the present disclosure. The BS 800 may be a BS 105 as discussed above. As shown, the BS 800 may include a processor 802, a memory 804, a resource allocation module 808, a transceiver 810 including a modem subsystem 812 and a RF unit 814, and one or more antennas 816. These elements may be coupled with each other and in direct or indirect communication with each other, for example via one or more buses.

The processor 802 may have various features as a specific-type processor. For example, these may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 804 may include a non-transitory computer-readable medium. The memory 804 may store instructions 806. The instructions 806 may include instructions that, when executed by the processor 802, cause the processor 802 to perform operations described herein, for example, aspects of FIGS. 2-6 and 10-11. Instructions 806 may also be referred to as code, which may be interpreted broadly to include any type of computer-readable statement(s).

The resource allocation module 808 may be implemented via hardware, software, or combinations thereof. For example, the resource allocation module 808 may be implemented as a processor, circuit, and/or instructions 806 stored in the memory 804 and executed by the processor 802.

In some aspects, the resource allocation module 808 may implement the aspects of FIGS. 2-6. For example, the resource allocation module 808 may receive, from a network node of a first network operator, a first consideration for shared spectrum resources. The resource allocation module 808 may receive, from a network node of a second network operator, a second consideration for the shared spectrum resources. The resource allocation module 808 may transmit an indication of a resource allocation to at least one of the network node of the first network operator or the network node of the second network operator. The resource allocation for the shared spectrum resources may be based on the first consideration and the second consideration

Additionally or alternatively, the resource allocation module 808 can be implemented in any combination of hardware and software, and may, in some implementations, involve, for example, processor 802, memory 804, instructions 806, transceiver 810, and/or modem 812.

As shown, the transceiver 810 may include the modem subsystem 812 and the RF unit 814. The transceiver 810 can be configured to communicate bi-directionally with other devices, such as the UEs 115 and/or 600. The modem subsystem 812 may be configured to modulate and/or encode data according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or UE 700. The RF unit 814 may be further configured to perform analog beamforming in conjunction with the digital beamforming. Although shown as integrated together in transceiver 810, the modem subsystem 812 and/or the RF unit 814 may be separate devices that are coupled together at the BS 800 to enable the BS 800 to communicate with other devices.

The RF unit 814 may provide the modulated and/or processed data, e.g. data packets (or, more generally, data messages that may contain one or more data packets and other information), to the antennas 816 for transmission to one or more other devices. This may include, for example, a configuration indicating a plurality of sub-slots within a slot according to aspects of the present disclosure. The antennas 816 may further receive data messages transmitted from other devices and provide the received data messages for processing and/or demodulation at the transceiver 810. The antennas 816 may include multiple antennas of similar or different designs in order to sustain multiple transmission links.

In some instances, the BS 800 can include multiple transceivers 810 implementing different RATs (e.g., NR and LTE). In some instances, the BS 800 can include a single transceiver 810 implementing multiple RATs (e.g., NR and LTE). In some instances, the transceiver 810 can include various components, where different combinations of components can implement RATs.

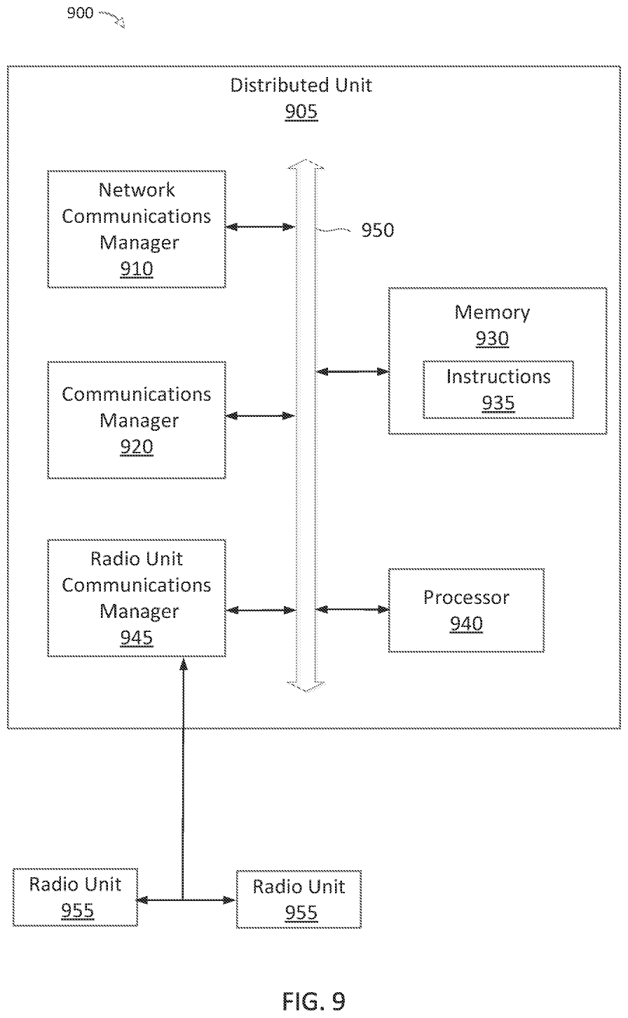

FIG. 9 is a block diagram of a system 900 including a DU 905 (e.g., DU 230) that supports RU sharing techniques in wireless communications according to some aspects of the present disclosure. The DU 905 may be an example of a DU or other network node as described herein. The DU 905 may communicate with one or more RUs 955 (e.g., RU 240). The DU 905 may include components for bi-directional voice and data communications including components for transmitting and receiving communications, such as a communications manager 920, a network communications manager 910, a memory 930, code 935, a processor 940, and a RU communications manager 945. These components may be in electronic communication or otherwise coupled (e.g., operatively, communicatively, functionally, electronically, electrically) via one or more buses (e.g., a bus 950).

The network communications manager 910 may manage communications with a core network (e.g., via one or more wired backhaul links). For example, the network communications manager 910 may manage the transfer of data communications for user equipment, such as one or more UEs 115.

The memory 930 may include RAM and/or ROM. The memory 930 may store computer-readable, computer-executable code 935 including instructions that, when executed by the processor 940, cause the DU 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some aspects, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some aspects, the processor 940 may be configured to operate a memory array using a memory controller. In some aspects, a memory controller may be integrated into the processor 940. The processor 940 may be configured to execute computer-readable instructions stored in a memory (e.g., the memory 930) to cause the DU 905 to perform various functions (e.g., functions or tasks supporting RU sharing techniques in wireless communications). For example, the DU 905 or a component of the DU 905 may include a processor 940 and memory 930 coupled to the processor 940, the processor 940 and memory 930 configured to perform various functions described herein.

The RU communications manager 945 may manage communications with RUs 955, and may include a controller or scheduler for controlling communications with UEs 115 in cooperation with RUs 955. For example, the RU communications manager 945 may coordinate scheduling for transmissions to UEs 115. In some examples, the RU communications manager 945 may provide an F1 interface within a wireless communications network technology to provide communication with RUs 955.

The communications manager 920 may support wireless communications at a network node in accordance with examples as disclosed herein. For example, the communications manager 920 may be configured as or otherwise support a means for transmitting, to the RU 955, a first consideration for shared spectrum resources. The communications manager 920 may be configured as or otherwise support a means for receiving, from the RU 955, an indication of a resource allocation associated with the shared spectrum resources. The resource allocation may be based on the first consideration for shared spectrum resources and a second consideration for the shared spectrum resources associated with a second network operator.

By including or configuring the communications manager 920 in accordance with examples as described herein, the DU 905 may support techniques for resource sharing in which DUs of different MNOs may access wireless resources of other MNOs based on consideration, which may increase efficiency of resource usage while providing for competition and innovation among different MNOs, increase the reliability of wireless communications, decrease latency, and enhance user experience.

In some examples, the communications manager 920 may be configured to perform various operations (e.g., receiving, monitoring, transmitting) using or otherwise in cooperation with other components. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the DU 905 to perform various aspects of RU sharing techniques in wireless communications as described herein, or the processor 940 and the memory 930 may be otherwise configured to perform or support such operations.

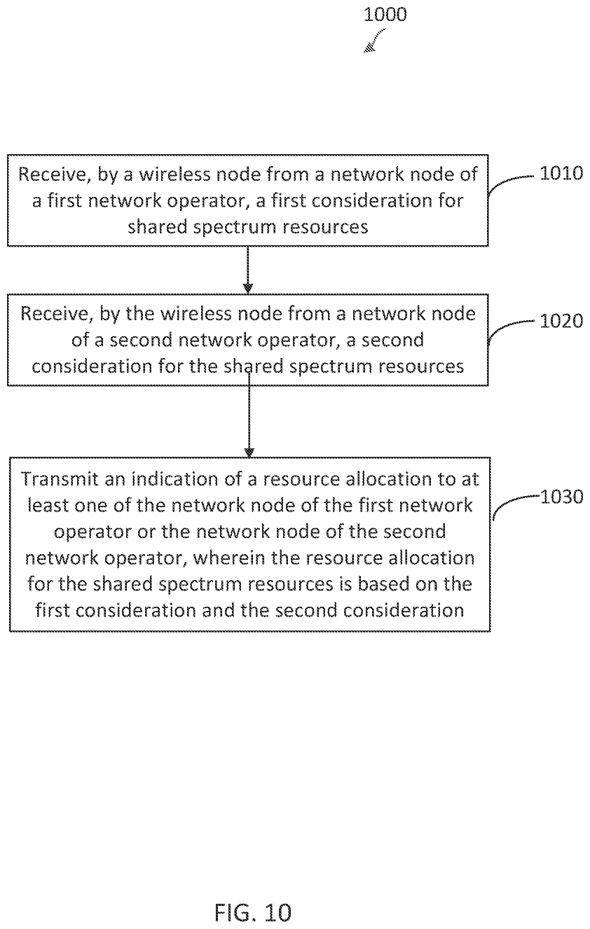

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the radio unit (RU) 955, may utilize one or more components to execute aspects of method 1000. The method 1000 may employ similar mechanisms as in the networks 100, 200, or 250 and the aspects and actions described with respect to FIGS. 2-6. As illustrated, the method 1000 includes a number of enumerated aspects, but the method 1000 may include additional aspects before, after, and in between the enumerated aspects. In some aspects, one or more of the enumerated aspects may be omitted or performed in a different order.

At 1010, the method 1000 includes an RU (e.g., the RU 955) receiving a first consideration for shared spectrum resources from a network node of a first network operator.

At 1020, the method 1000 includes the RU (e.g., the RU 955) receiving a second consideration for the shared spectrum resources from a network node of a second network operator.

The first network operator and the second network operator may be mobile network operators (MNOs). In some aspects, multiple MNOs may access wireless communication networks 100, 200, or 250 and perform spectrum sharing using shared RUs. The multiple different MNOs may access a same RU for transmission and reception of over the air signals to and from one or more UEs (e.g., the UEs 115 or 700). In some aspects, the network node may include a distributed unit (e.g., the DU 905). In some instances, the DU and/or the RU may be implemented in a disaggregated base station architecture. In some aspects, a shared RU may receive requests for resources from two or more network nodes (e.g., DUs) of different MNOs for wireless resources. Each RU may be a separate cell or a number of RUs may belong to the same cell. One or more RUs may be shared RUs that may be interconnected with DUs of multiple different MNOs. A number of RUs may be shared among all of the MNOs and each RU may be interconnected with a DU of each MNO. Thus, multiple DUs belonging to different MNOs may be connected to a common, shared RU. Each RU may be configured to transmit and/or receive (e.g., via one or multiple antennas) on different frequencies, such that spectrum associated with each MNO is accessible via the RUs.

In some aspects, one or more RUs may be owned and operated by a site owner (e.g., a particular MNO) and the site owner may also own the spectrum for communications in the relevant geographical area such that each MNO may desire to access to the site owner's RUs and spectrum. In such cases, one or more of the MNOs may not have purchased the spectrum, but may lease the spectrum from the site/spectrum owner. In other cases, one or more MNOs may own one or more shared RUs and/or an associated portion of the spectrum (e.g., a set of frequencies on which the MNO may have ownership and/or priority over all other operators). In some instances, priority among the non-spectrum owning MNOs for access to the RUs and/or spectrum may be based on various factors, such as consideration offered for the spectrum, fee payment, reciprocal priority sharing, etc. In some aspects, government regulators and/or spectrum managers may influence RU sharing through policy and/or conditions when spectrum is shared. In some aspects, each DU may transmit a request for resources to one or more RUs. The one or more RUs may determine the available resources for each DU and provide an indication (e.g., a resource allocation) back to the DU indicating the resources that are available to the DU.

In some aspects, the first consideration and/or the second consideration may include, without limitation, a token, a currency, a cryptocurrency, a digital currency, or a combination thereof. The token may include a digital token that represents an amount of digital resources and/or time/frequency resources. The digital token may be owned, assigned, redeemed, converted, and/or exchanged for other forms of consideration by the MNO. In some aspects, the currency may include any form or type of currency. For example, the currency may include money (e.g., dollars, Euros, Yen, etc.) in any form or circulation as a medium of consideration offering and/or exchange. The cryptocurrency (e.g., Bitcoin, Ethereum, etc.) may include any type and/or collection of data which is designed to work as a medium of consideration exchange. The cryptocurrency may be implemented with decentralized control through distributed ledger technology, such as a blockchain. The digital currency may include any currency, money, or asset that is managed, stored and/or exchanged on one or more digital computer systems.

The shared spectrum resources may refer to a combination of radio frequency resource(s), time resource(s), and/or spatial resource(s) (e.g., spatial layers or beam directions). In some aspects, the time resources may include time intervals of a communications resource organized according to radio frames each having a specified duration (e.g., 10 milliseconds (ms)). Each radio frame may be identified by a system frame number (SFN) (e.g., ranging from 0 to 1023). Each radio frame may include multiple consecutively numbered subframes or slots. Each subframe or slot may have the same or different duration (e.g., 1 ms). In some aspects, a radio frame may be divided in the time domain into subframes, and each subframe may be further divided into a number of slots. Additionally or alternatively, each frame may include a variable number of slots and the number of slots may depend on a frequency subcarrier spacing. Each slot may include a number of symbol periods (e.g., depending on the length of the cyclic prefix associated with each symbol period). In some aspects, a slot may further be divided into multiple mini-slots containing one or more symbols. The duration of a symbol period may depend on the subcarrier spacing or frequency band of operation. In some aspects, a subframe, a slot, a mini-slot, or a symbol may be the smallest time resource unit in the time domain (e.g., a transmission time interval (TTI)) of the shared spectrum resource allocation. In some aspects, the TTI duration (e.g., the number of symbol periods in a TTI) may be variable. Additionally or alternatively, the smallest time resource unit of the resource allocation may be dynamically selected (e.g., selected in bursts of shortened TTIs).

In some aspects, the shared spectrum resources may include one or more frequency bands. The frequency bands may include any frequency range. For example, the frequency bands may include a frequency carrier, a frequency spectrum, a subchannel, a bandwidth, a bandwidth part, a subcarrier, or any suitable frequency band. In some aspects, the frequency band in the shared spectrum resources may include a licensed and/or an unlicensed frequency band.

The frequency band may be operated according to one or more physical layer channels for a given radio access technology (e.g., E-UTRA, LTE, LTE-A, LTE-A Pro, NR, WiFi, sidelink, etc.). In some aspects, the frequency band may be one of a number of determined bandwidths for carriers of a particular radio access technology (e.g., 1.4, 3, 5, 10, 15, 20, 40, or 80 megahertz (MHz)). The frequency bands may be allocated as a single (e.g., continuous) frequency band and/or multiple frequency bands (e.g., subchannels). The multiple frequency bands may be continuous and/or separate frequency bands. In some aspects, the multiple frequency bands may include a set of interlaced frequency resources. The interlaced frequency resources may configured with a number of frequency interlaces in the frequency band, an interlace-spacing (e.g., the frequency separation among interlaced frequency resources within a frequency interlace), and/or a frequency interlace size (e.g., the number of interlaced frequency resources within a frequency interlace). The frequency band may be configured with frequency interlaces of equal sizes in a frequency band. In some instances, a frequency band may be configured with frequency interlaces of multiple sizes. Devices of the wireless communications network 100, 200, or 250 (e.g., the base stations 105, the UEs 115, and/or the RUs 955) may have hardware configurations that support communications over a particular carrier bandwidth or may be configurable to support communications over one of a set of frequency bands. In some aspects, the wireless communications network 100, 200, or 250 may support simultaneous communications via carriers associated with multiple frequency bands. The wireless communications network 100, 200, or 250 may be configured for operating over portions (e.g., a sub-band, a BWP) or all of a frequency band.

In some aspects, the shared spectrum resources may include wireless resources associated with one or more beam directions. The beam may include spatial resources or spatial layers and be used to implement beamforming. In some aspects, beamforming may be used at a transmitting device or a receiving device (e.g., a base station 105, a UE 115, and/or an RU 955) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The use of beamforming using multiple beams may further increase the data rate, coverage area, and/or data integrity for communications between an RU and a UE. The beam resources may be allocated based on one or more beam indexes and/or geographic areas (e.g., one or more ranges of azimuth angles and/or elevation angles relative to the RU).

At 1030, the method 1000 includes an RU (e.g., the RU 955) transmitting an indication of a resource allocation to the network node (e.g., DU) of the first network operator or the network node (e.g., DU) of the second network operator. In some aspects, the RU may transmit the indication via a communication link. The communication link may be a wired and/or a wireless communication link. The communication link may implement an open fronthaul control user synchronization (CUS) plane interface and/or an open fronthaul control plane interface.

In some aspects, the resource allocation for the shared spectrum resources may be based on the first consideration and/or the second consideration. The RU may, at actions 1010 and/or 1020, receive the first consideration and/or the second consideration for the same shared spectrum resources (e.g., completely overlapping time, frequency, and/or beam resources). In this case, the RU may determine the resource allocation based on the highest and/or better of the first consideration and the second consideration. If the first consideration is higher and/or better than the second consideration, then the RU may allocate some or all of the shared spectrum resources to the first MNO. If the second consideration is higher and/or better than the first consideration, then the RU may allocate some or all of the shared spectrum resources to the second MNO. The allocation of shared spectrum resources by the RU may be based on consideration offers from any number of network operators that may share the RUs and/or spectrum resources. For example, the RU may also receive a third (a fourth, a fifth, etc.) consideration for the same shared spectrum resources. If the third (fourth, fifth, etc.) consideration is higher than the first and/or second considerations, then the RU may allocate some or all of the shared spectrum resources to the third (fourth, fifth, etc.) MNO. In some aspects, the RU may indicate the resource allocation to one or more of the DUs of the resource requesting MNOs. In some instances, when a requesting MNO is not allocated the requested resources based on the offered consideration, then the MNO may submit one or more additional considerations (e.g., increased consideration) for the requested resources. The RU may allocate the requested resources based on the increased consideration.

In some aspects, the RU may allocate the requested resources based on communication service metrics. For example, the MNO may request shared resources for communications. The MNO may indicate a quality of service (QOS) associated with the communications. The MNO may offer consideration based on the QOS associated with the data traffic to be communicated by the MNO. The RU may determine the resource allocation based on the consideration offered by the MNO and/or the QOS metrics associated with the data traffic to be communicated by the MNO. In some aspects, the RU may set a minimum level of QOS for the MNO to meet in order to be allocated the shared resources. The QOS metrics may include, without limitation, an aggregate data throughput, a maximum average latency, a maximum block error rate, or a combination thereof.

In some aspects, the RU may receive the first consideration and the second consideration for partially overlapping time and/or frequency resources. For example, the first MNO may transmit a request and associated first consideration to the RU for shared spectrum resources including slot indexes 0-6, while the second MNO may transmit a request and associated second consideration to the RU for shared spectrum resources including slot indexes 4-9. In this case, the RU may determine the resource allocation based on the highest of the first consideration and the second consideration for the overlapping resources in slot indexes 4-6. If the first consideration is higher than the second consideration, then the RU may allocate slot indexes 0-6 to the first MNO. The RU may allocate slots 7-9 to the second MNO based on the second MNO indicating that it will accept a partial allocation of the requested resources. If the second consideration is higher than the first consideration, then the RU may allocate slot indexes 4-9 to the second MNO. The RU may allocate slots 0-3 to the first MNO based on the first MNO indicating that it will accept a partial allocation of the requested resources. Again, the allocation of shared spectrum resources by the RU is not limited to the first and second MNOs. For example, the RU may also receive a third consideration for shared spectrum resources including slot indexes 4-6. If the third consideration is higher than the first and second considerations, then the RU may allocate slot indexes 4-6 to the third MNO. The RU may allocate slots 0-3 to the first MNO based on the first MNO indicating that it will accept a partial allocation of the requested resources. The RU may allocate slots 7-9 to the second MNO based on the second MNO indicating that it will accept a partial allocation of the requested resources.

In some aspects, the RU may receive the first consideration and the second consideration for non-overlapping (e.g., exclusive) time resources. For example, the first MNO may transmit a request and associated first consideration to the RU for shared spectrum resources including slot indexes 0-4, while the second MNO may transmit a request and associated second consideration to the RU for shared spectrum resources including slot indexes 5-9. In this case, since the first and second MNOs are not requesting any of the same time resources, the RU may allocate the requested slots 0-4 to the first MNO and allocate the requested slots 5-9 to the second MNO.

Although the examples above describe allocation of complete overlapping, partial overlapping, and non-overlapping shared spectrum resources on a time slot basis, the present disclosure is not so limited and the allocation of shared spectrum resources may be based on other time resources (e.g., radio frames, sub-slots, symbols, etc.). Further, while the examples provided above are relative to overlapping time resources, similar approaches may be used for overlapping frequency resources and/or overlapping time and frequency resources.

In some aspects, the RU may receive the first consideration and the second consideration for partially overlapping time and/or frequency band resources. For example, the first MNO may transmit a request and associated first consideration to the RU for shared spectrum resources including subchannel indexes 0-1, while the second MNO may transmit a request and associated second consideration to the RU for shared spectrum resources including subchannel indexes 1-2. In this case, the RU may determine the resource allocation based on the highest of the first consideration and the second consideration for the overlapping resources in subchannel index 1. If the first consideration is higher than the second consideration, then the RU may allocate subchannel indexes 0-1 to the first MNO. The RU may allocate subchannel index 2 to the second MNO based on the second MNO indicating that it will accept a partial allocation of the requested resources. If the second consideration is higher than the first consideration, then the RU may allocate subchannel indexes 1-2 to the second MNO. The RU may allocate subchannel index 0 to the first MNO based on the first MNO indicating that it will accept a partial allocation of the requested resources. Again, the allocation of shared spectrum resources by the RU is not limited to the first and second MNOs. For example, the RU may also receive a third consideration for shared spectrum resources including subchannel indexes 1-2. If the third consideration is higher than the first and second considerations, then the RU may allocate subchannel indexes 1-2 to the third MNO. The RU may allocate subchannel index 0 to the first MNO based on the first MNO indicating that it will accept a partial allocation of the requested resources.

In some aspects, the RU may receive the first consideration and the second consideration for non-overlapping (e.g., exclusive) frequency resources. For example, the first MNO may transmit a request and associated first consideration to the RU for shared spectrum resources including subchannel index 0 while the second MNO may transmit a request and associated second consideration to the RU for shared spectrum resources including subchannel indexes 1-2. In this case, since the first and second MNOs are not requesting any of the same frequency resources, the RU may allocate the requested subchannel 0 to the first MNO and allocate the requested subchannels 1-2 to the second MNO. Although the examples above describe allocation of complete overlapping, partial overlapping, and non-overlapping shared spectrum resources on a subchannel basis, the present disclosure is not so limited and the allocation may be based on other frequency resources (e.g., frequency bands, frequency carriers, frequency spectrums, a bandwidth, a bandwidth part, etc.).

In some aspects, the RU may receive the first consideration and the second consideration for partially overlapping spatial (e.g., beam) resources. For example, the first MNO may transmit a request and associated first consideration to the RU for shared spectrum resources including beam indexes 0-5, while the second MNO may transmit a request and associated second consideration to the RU for shared spectrum resources including beam indexes 3-7. In this case, the RU may determine the resource allocation based on the highest of the first consideration and the second consideration for the overlapping resources in beam indexes 3-5. If the first consideration is higher than the second consideration, then the RU may allocate beam indexes 0-5 to the first MNO. The RU may allocate beam indexes 6-7 to the second MNO based on the second MNO indicating that it will accept a partial allocation of the requested resources. If the second consideration is higher than the first consideration, then the RU may allocate beam indexes 3-7 to the second MNO. The RU may allocate beam indexes 0-2 to the first MNO based on the first MNO indicating that it will accept a partial allocation of the requested resources. The allocation of shared spectrum resources by the RU is not limited to the first and second MNOs and any number of operators may share the spectrum resources. For example, the RU may also receive a third consideration for shared spectrum resources including beam indexes 3-7. If the third consideration is higher than the first and second considerations, then the RU may allocate beam indexes 3-7 to the third MNO. The RU may allocate beam indexes 0-2 to the first MNO based on the first MNO indicating that it will accept a partial allocation of the requested resources.

In some aspects, the RU may receive the first consideration and the second consideration for non-overlapping (e.g., exclusive) frequency resources. For example, the first MNO may transmit a request and associated first consideration to the RU for shared spectrum resources including beam indexes 0-3 while the second MNO may transmit a request and associated second consideration to the RU for shared spectrum resources including beam indexes 4-7. In this case, since the first and second MNOs are not requesting any of the same beam resources, the RU may allocate the requested beam indexes 0-3 to the first MNO and allocate the requested beams 4-7 to the second MNO. Although the examples above describe allocation of complete overlapping, partial overlapping, and non-overlapping shared spectrum resources on a beam basis, the present disclosure is not so limited and the allocation may be based on other spatial resources (e.g., one or more ranges of azimuth angles and/or elevation angles relative to the RU). Further, while the examples provided above are relative to overlapping frequency resources, similar approaches may be used for overlapping time resources and/or overlapping time and frequency resources.

In some aspects, the resource allocation for the shared spectrum resources may be further based on a maximum inter-beam interference level. When the first MNO offers consideration for beam resources (e.g., beam resources that are adjacent to beam resources requested by the second MNO that may cause inter-beam interference), the first MNO may also indicate a maximum level of inter-beam interference that the first MNO is willing to tolerate. For example, the first MNO may request a beam resource during time period T1 while the second MNO requests an adjacent beam during time period T1. In some aspects, the adjacent beam requested by the second MNO may interfere with the beam requested by the first MNO. The first MNO may indicate a maximum inter-beam interference level that the first MNO is willing to tolerate. In some aspects, the maximum level of inter-beam interference may apply to the request for resources during time period T1 and/or during any time period. The time period T1 may be updated for each beam resource request and/or for a set of beam resource requests. The RU may determine whether the maximum inter-beam interference level may be met and indicate such to the first MNO. The first MNO may cancel or confirm the beam resource request based on the RUs determination as to whether the maximum inter-beam interference level can be met.

In some aspects, a shared RU may receive requests for resources (e.g., fully overlapping resources or partially overlapping resources) from two or more DUs of two or more different MNOs for shared spectrum resources in a first time period. The RU may determine a resource allocation for the first time period based on the priorities associated with the two or more different MNOs. In some aspects, a first MNO may have a higher priority than a second MNO or a third MNO. The resources may be allocated to the first MNO ahead of the second MNO or the third MNO based on the higher priority of the first MNO. The RU may transmit the resource allocation to each of the network nodes of the different MNOS that transmitted requests for resources.

In some aspects, a first MNO may have priority for a first frequency band of shared spectrum resources and may share one or more RUs with a second MNO that has priority for a second frequency band of the shared spectrum resources. The RU may receive a request for resources from DUs of multiple different operators, and prioritize allocation of resources based on a priority associated with an MNO of each DU. The first MNO may have a highest priority for the first frequency range of the RU and the second operator may have a lower priority for the first frequency range. The resource requests of the second MNO may be allocated for resources that are unused by the first MNO. Such techniques may allow for enhanced spectrum usage efficiency, which may enhance overall user experience for each MNO. Through prioritized resource sharing, an MNO may have priority for associated resources (e.g., time, frequency, or spatial resources), and different MNOs may be differentiated based on key performance indicators (KPIs), such as overall network latency, data rates, and the like. Thus, aspects of the present disclosure may allow spectrum regulators to enhance utilization of wireless resources while also promoting competition and innovation through KPI differences between different MNOs.

Aspects of the present disclosure may provide a handshake procedure that may be utilized for resource reservation between the DUs and the shared RUs. In some aspects, for a given resource, priority MNOs may have an opportunity to reserve its priority resources first and all unreserved resources may be allocated (e.g., allocated based on consideration) to nonpriority MNOs.

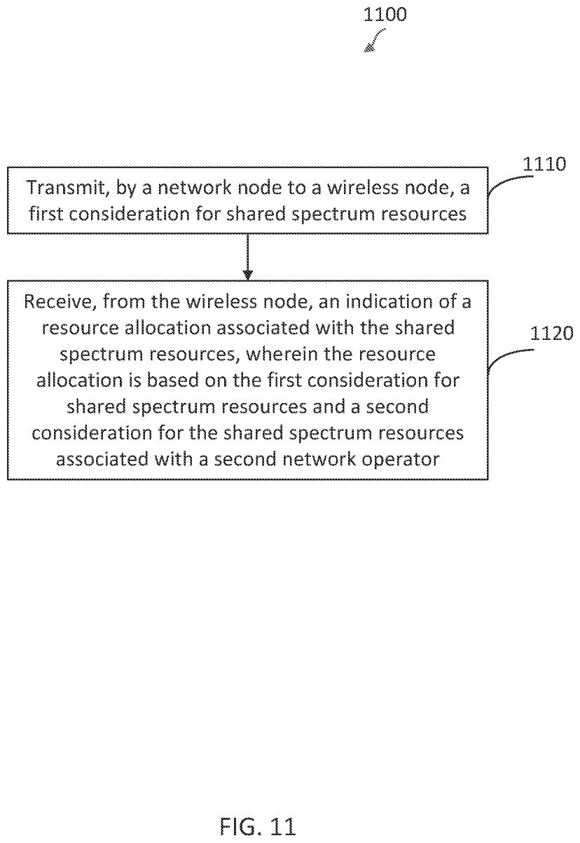

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. The method 1100 may employ similar mechanisms as in the networks 100, 200, or 250 and the aspects and actions described with respect to FIGS. 2-6. For example, a wireless communication device, such as a distributed unit (DU) 905, may utilize one or more components, such as network communications manager 910, communications manager 920, RU communications manager 945, memory 930, instructions 935, and processor 940 to execute aspects of the method 1100. As illustrated, the method 1100 includes a number of enumerated aspects, but the method 1100 may include additional aspects before, after, and in between the enumerated aspects. In some aspects, one or more of the enumerated aspects may be omitted or performed in a different order.

At 1110, the method 1100 includes a network node of a first network operator (e.g., the DU 905) transmitting a first consideration for shared spectrum resources to a wireless node.

The first network operator may be a mobile network operator (MNO). In some aspects, multiple MNOs may access wireless communication networks 100, 200, or 250 and perform spectrum sharing using shared RUs. The multiple different MNOs may access a same RU for transmission and reception of over the air signals to and from one or more UEs (e.g., the UEs 115 or 700). In some aspects, the wireless node may include a radio unit (RU) (e.g., the RU 955). In some instances, the DU and/or the RU may be implemented in a disaggregated base station architecture. In some aspects, a shared RU may receive requests for resources from two or more network nodes (e.g., DUs) of different MNOs for wireless resources. Each RU may be a separate cell or a number of RUs may belong to the same cell. One or more RUs may be shared RUs that may be interconnected with DUs of multiple different MNOs. A number of RUs may be shared among all of the MNOs and each RU may be interconnected with a DU of each MNO. Thus, multiple DUs belonging to different MNOs may be connected to a common, shared RU. Each RU may be configured to transmit and/or receive (e.g., via one or multiple antennas) on different frequencies, such that spectrum associated with each MNO is accessible via the RUs.

In some aspects, one or more RUs may be owned and operated by a site owner (e.g., a particular MNO) and the site owner may also own the spectrum for communications in the relevant geographical area such that each MNO may desire to access to the site owner's RUs and spectrum. In such cases, one or more of the MNOs may not have purchased the spectrum, but may lease the spectrum from the site/spectrum owner. In other cases, one or more MNOs may own one or more shared RUs and/or an associated portion of the spectrum (e.g., a set of frequencies on which the MNO may have ownership and/or priority over all other operators). In some instances, priority among the non-spectrum owning MNOs for access to the RUs and/or spectrum may be based on various factors, such as consideration offered for the spectrum, fee payment, reciprocal priority sharing, etc. In some aspects, government regulators and/or spectrum managers may influence RU sharing through policy and/or conditions when spectrum is shared. In some aspects, each DU may transmit a request for resources to one or more RUs. The one or more RUs may determine the available resources for each DU and provide an indication (e.g., a resource allocation) back to the DU indicating the resources that are available to the DU.

In some aspects, the first consideration and/or the second consideration may include, without limitation, a token, a currency, a cryptocurrency, a digital currency, or a combination thereof. The token may include a digital token that represents an amount of digital resources and/or time/frequency resources. The digital token may be owned, assigned, redeemed, converted, and/or exchanged for other forms of consideration by the MNO. In some aspects, the currency may include any form or type of currency. For example, the currency may include money (e.g., dollars, Euros, Yen, etc.) in any form or circulation as a medium of consideration offering and/or exchange. The cryptocurrency (e.g., Bitcoin, Ethereum, etc.) may include any type and/or collection of data which is designed to work as a medium of consideration exchange. The cryptocurrency may be implemented with decentralized control through distributed ledger technology, such as a blockchain. The digital currency may include any currency, money, or asset that is managed, stored and/or exchanged on one or more digital computer systems.

The shared spectrum resources may refer to a combination of radio frequency resource(s), time resource(s), and/or spatial resource(s) (e.g., spatial layers or beam directions). In some aspects, the time resources may include time intervals of a communications resource organized according to radio frames each having a specified duration (e.g., 10 milliseconds (ms)). Each radio frame may be identified by a system frame number (SFN) (e.g., ranging from 0 to 1023). Each radio frame may include multiple consecutively numbered subframes or slots. Each subframe or slot may have the same or different duration (e.g., 1 ms). In some aspects, a radio frame may be divided in the time domain into subframes, and each subframe may be further divided into a number of slots. Additionally or alternatively, each frame may include a variable number of slots and the number of slots may depend on a frequency subcarrier spacing. Each slot may include a number of symbol periods (e.g., depending on the length of the cyclic prefix associated with each symbol period). In some aspects, a slot may further be divided into multiple mini-slots containing one or more symbols. The duration of a symbol period may depend on the subcarrier spacing or frequency band of operation. In some aspects, a subframe, a slot, a mini-slot, or a symbol may be the smallest time resource unit in the time domain (e.g., a transmission time interval (TTI)) of the shared spectrum resource allocation. In some aspects, the TTI duration (e.g., the number of symbol periods in a TTI) may be variable. Additionally or alternatively, the smallest time resource unit of the resource allocation may be dynamically selected (e.g., selected in bursts of shortened TTIs).

In some aspects, the shared spectrum resources may include one or more frequency bands. The frequency bands may include any frequency range. For example, the frequency bands may include a frequency carrier, a frequency spectrum, a subchannel, a bandwidth, a bandwidth part, a subcarrier, or any suitable frequency band. In some aspects, the frequency band in the shared spectrum resources may include a licensed and/or an unlicensed frequency band.

The frequency band may be operated according to one or more physical layer channels for a given radio access technology (e.g., E-UTRA, LTE, LTE-A, LTE-A Pro, NR, WiFi, sidelink, etc.). In some aspects, the frequency band may be one of a number of determined bandwidths for carriers of a particular radio access technology (e.g., 1.4, 3, 5, 10, 15, 20, 40, or 80 megahertz (MHz)). The frequency bands may be allocated as a single (e.g., continuous) frequency band and/or multiple frequency bands (e.g., subchannels). The multiple frequency bands may be continuous and/or separate frequency bands. In some aspects, the multiple frequency bands may include a set of interlaced frequency resources. The interlaced frequency resources may configured with a number of frequency interlaces in the frequency band, an interlace-spacing (e.g., the frequency separation among interlaced frequency resources within a frequency interlace), and/or a frequency interlace size (e.g., the number of interlaced frequency resources within a frequency interlace). The frequency band may be configured with frequency interlaces of equal sizes in a frequency band. In some instances, a frequency band may be configured with frequency interlaces of multiple sizes. Devices of the wireless communications network 100, 200, or 250 (e.g., the base stations 105, the UEs 115, the DUs 905 and/or the RUs 955) may have hardware configurations that support communications over a particular carrier bandwidth or may be configurable to support communications over one of a set of frequency bands. In some aspects, the wireless communications network 100, 200, or 250 may support simultaneous communications via carriers associated with multiple frequency bands. The wireless communications network 100, 200, or 250 may be configured for operating over portions (e.g., a sub-band, a BWP) or all of a frequency band.

In some aspects, the shared spectrum resources may include wireless resources associated with one or more beam directions. The beam may include spatial resources or spatial layers and be used to implement beamforming. In some aspects, beamforming may be used at a transmitting device and/or a receiving device (e.g., a base station 105, a UE 115, a DU 905, and/or an RU 955) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The use of beamforming using multiple beams may further increase the data rate, coverage area, and/or data integrity for communications between an RU and a UE. The beam resources may be allocated based on one or more beam indexes and/or geographic areas (e.g., one or more ranges of azimuth angles and/or elevation angles relative to the RU).

At 1120, the method 1100 includes a DU (e.g., the DU 905) receiving an indication from the RU of a resource allocation associated with the shared spectrum resources. The resource allocation may be based on the first consideration for shared spectrum resources and a second consideration for the shared spectrum resources associated with a second MNO. In some aspects, the DU may receive the indication via a communication link. The communication link may be a wired and/or a wireless communication link. The communication link may implement an open fronthaul control user synchronization (CUS) plane interface and/or an open fronthaul management plane interface.

In some aspects, the resource allocation for the shared spectrum resources may be based on the first consideration and/or the second consideration. The RU may receive the first consideration and/or the second consideration for the same shared spectrum resources (e.g., completely overlapping time, frequency, and/or beam resources). In this case, the RU may determine the resource allocation based on the highest and/or better of the first consideration and the second consideration. If the first consideration is higher and/or better than the second consideration, then the RU may allocate some or all of the shared spectrum resources to the first MNO. If the second consideration is higher and/or better than the first consideration, then the RU may allocate some or all of the shared spectrum resources to the second MNO. The allocation of shared spectrum resources by the RU may be based on consideration offers from any number of network operators that may share the RUs and/or spectrum resources. For example, the RU may also receive a third (a fourth, a fifth, etc.) consideration for the same shared spectrum resources. If the third (fourth, fifth, etc.) consideration is higher than the first and/or second considerations, then the RU may allocate some or all of the shared spectrum resources to the third (fourth, fifth, etc.) MNO. In some aspects, the RU may indicate the resource allocation to one or more of the DUs of the resource requesting MNOs. In some instances, when a requesting MNO is not allocated the requested resources based on the offered consideration, then the MNO may submit one or more additional considerations (e.g., increased consideration) for the requested resources. The RU may allocate the requested resources based on the increased consideration. In some aspects, the DU may transmit a request for resources and associated consideration to multiple RUs.

In some aspects, the RU may allocate the requested resources based on communication service metrics. For example, the MNO may request shared resources for communications. The MNO may indicate a quality of service (QOS) associated with the communications. The RU may determine the resource allocation based on the consideration and/or the QOS metrics. In some aspects, the RU may set a minimum level of QOS for the MNO to meet in order to be allocated the shared resources. The QOS metrics may include, without limitation, an aggregate data throughput, a maximum average latency, a maximum block error rate, or a combination thereof.

In some aspects, the DU may transmit the resource request and first consideration for resources that partially overlap time and/or frequency resources requested by another MNO. For example, the first MNO may transmit a request and associated first consideration to the RU for shared spectrum resources including slot indexes 0-6, while the second MNO may transmit a request and associated second consideration to the RU for shared spectrum resources including slot indexes 4-9. In this case, the RU may determine the resource allocation based on the highest of the first consideration and the second consideration for the overlapping resources in slot indexes 4-6. If the first consideration is higher and/or better than the second consideration, then the RU may allocate slot indexes 0-6 to the first MNO. The RU may allocate slots 7-9 to the second MNO based on the second MNO indicating that it will accept a partial allocation of the requested resources. If the second consideration is higher and/or better than the first consideration, then the RU may allocate slot indexes 4-9 to the second MNO. The RU may allocate slots 0-3 to the first MNO based on the first MNO indicating that it will accept a partial allocation of the requested resources. Again, the allocation of shared spectrum resources by the RU is not limited to the first and second MNOs. For example, the RU may also receive a third consideration for shared spectrum resources including slot indexes 4-6. If the third consideration is higher and/or better than the first and second considerations, then the RU may allocate slot indexes 4-6 to the third MNO. The RU may allocate slots 0-3 to the first MNO based on the first MNO indicating that it will accept a partial allocation of the requested resources. The RU may allocate slots 7-9 to the second MNO based on the second MNO indicating that it will accept a partial allocation of the requested resources.

In some aspects, the DU may transmit the resource request and first consideration for resources that are non-overlapping (e.g., exclusive) with time resources requested by another MNO. For example, the first MNO may transmit a request and associated first consideration to the RU for shared spectrum resources including slot indexes 0-4, while the second MNO may transmit a request and associated second consideration to the RU for shared spectrum resources including slot indexes 5-9. In this case, since the first and second MNOs are not requesting any of the same time resources, the RU may allocate the requested slots 0-4 to the first MNO and allocate the requested slots 5-9 to the second MNO.

Although the examples above describe allocation of complete overlapping, partial overlapping, and non-overlapping shared spectrum resources on a time slot basis, the present disclosure is not so limited and the allocation of shared spectrum resources may be based on other time resources (e.g., radio frames, sub-slots, symbols, etc.). Further, while the examples provided above are relative to overlapping time resources, similar approaches may be used for overlapping frequency resources and/or overlapping time and frequency resources.

In some aspects, the DU may transmit the resource request and first consideration for resources that partially overlap time and/or frequency resources requested by another MNO. For example, the first MNO may transmit a request and associated first consideration to the RU for shared spectrum resources including subchannel indexes 0-1, while the second MNO may transmit a request and associated second consideration to the RU for shared spectrum resources including subchannel indexes 1-2. In this case, the RU may determine the resource allocation based on the highest of the first consideration and the second consideration for the overlapping resources in subchannel index 1. If the first consideration is higher and/or better than the second consideration, then the RU may allocate subchannel indexes 0-1 to the first MNO. The RU may allocate subchannel index 2 to the second MNO based on the second MNO indicating that it will accept a partial allocation of the requested resources. If the second consideration is higher and/or better than the first consideration, then the RU may allocate subchannel indexes 1-2 to the second MNO. The RU may allocate subchannel index 0 to the first MNO based on the first MNO indicating that it will accept a partial allocation of the requested resources. Again, the allocation of shared spectrum resources by the RU is not limited to the first and second MNOs. For example, the RU may also receive a third consideration for shared spectrum resources including subchannel indexes 1-2. If the third consideration is higher and/or better than the first and second considerations, then the RU may allocate subchannel indexes 1-2 to the third MNO. The RU may allocate subchannel index 0 to the first MNO based on the first MNO indicating that it will accept a partial allocation of the requested resources.

In some aspects, the DU may transmit the resource request and first consideration for resources that are non-overlapping (e.g., exclusive) with frequency resources requested by another MNO. For example, the first MNO may transmit a request and associated first consideration to the RU for shared spectrum resources including subchannel index 0 while the second MNO may transmit a request and associated second consideration to the RU for shared spectrum resources including subchannel indexes 1-2. In this case, since the first and second MNOs are not requesting any of the same frequency resources, the RU may allocate the requested subchannel 0 to the first MNO and allocate the requested subchannels 1-2 to the second MNO. Although the examples above describe allocation of complete overlapping, partial overlapping, and non-overlapping shared spectrum resources on a subchannel basis, the present disclosure is not so limited and the allocation may be based on other frequency resources (e.g., frequency bands, frequency carriers, frequency spectrums, a bandwidth, a bandwidth part, etc.).

In some aspects, the RU may receive the first consideration and the second consideration for partially overlapping spatial (e.g., beam) resources. For example, the DU of the first MNO may transmit a request and associated first consideration to the RU for shared spectrum resources including beam indexes 0-5, while the DU of the second MNO may transmit a request and associated second consideration to the RU for shared spectrum resources including beam indexes 3-7. In this case, the RU may determine the resource allocation based on the higher and/or better of the first consideration and the second consideration for the overlapping resources in beam indexes 3-5. If the first consideration is higher and/or better than the second consideration, then the RU may allocate beam indexes 0-5 to the first MNO. The RU may allocate beam indexes 6-7 to the second MNO based on the second MNO indicating that it will accept a partial allocation of the requested resources. If the second consideration is higher and/or better than the first consideration, then the RU may allocate beam indexes 3-7 to the second MNO. The RU may allocate beam indexes 0-2 to the first MNO based on the first MNO indicating that it will accept a partial allocation of the requested resources. The allocation of shared spectrum resources by the RU is not limited to the first and second MNOs and any number of operators may share the spectrum resources. For example, the RU may also receive a third consideration for shared spectrum resources including beam indexes 3-7. If the third consideration is higher and/or better than the first and second considerations, then the RU may allocate beam indexes 3-7 to the third MNO. The RU may allocate beam indexes 0-2 to the first MNO based on the first MNO indicating that it will accept a partial allocation of the requested resources.

In some aspects, the RU may receive the first consideration and the second consideration for non-overlapping (e.g., exclusive) frequency resources. For example, the DU of the first MNO may transmit a request and associated first consideration to the RU for shared spectrum resources including beam indexes 0-3 while the DU of the second MNO may transmit a request and associated second consideration to the RU for shared spectrum resources including beam indexes 4-7. In this case, since the first and second MNOs are not requesting any of the same beam resources, the RU may allocate the requested beam indexes 0-3 to the first MNO and allocate the requested beams 4-7 to the second MNO. Although the examples above describe allocation of complete overlapping, partial overlapping, and non-overlapping shared spectrum resources on a beam basis, the present disclosure is not so limited and the allocation may be based on other spatial resources (e.g., one or more ranges of azimuth angles and/or elevation angles relative to the RU). Further, while the examples provided above are relative to overlapping frequency resources, similar approaches may be used for overlapping time resources and/or overlapping time and frequency resources.

In some aspects, the resource allocation for the shared spectrum resources may be further based on a maximum inter-beam interference level. When the first MNO offers consideration for beam resources (e.g., beam resources that are adjacent to beam resources requested by the second MNO that may cause inter-beam interference), the first MNO may also indicate a maximum level of inter-beam interference that the first MNO is willing to tolerate. For example, the first MNO may request a beam resource during time period T1 while the second MNO requests an adjacent beam during time period T1. In some aspects, the adjacent beam requested by the second MNO may interfere with the beam requested by the first MNO. The first MNO may indicate a maximum inter-beam interference level that the first MNO is willing to tolerate. The RU may determine whether the maximum inter-beam interference level may be met and indicate such to the first MNO. The first MNO may cancel or confirm the beam resource request based on the RUs determination as to whether the maximum inter-beam interference level can be met.

In some aspects, a shared RU may receive requests for resources (e.g., fully overlapping resources or partially overlapping resources) from two or more DUs of two or more different MNOs for shared spectrum resources in a first time period. The RU may determine a resource allocation for the first time period based on the priorities associated with the two or more different MNOs. In some aspects, a first MNO may have a higher priority than a second MNO or a third MNO. The resources may be allocated to the first MNO ahead of the second MNO or the third MNO based on the higher priority of the first MNO. The RU may transmit the resource allocation to each of the network nodes of the different MNOS that transmitted requests for resources.

In some aspects, a first MNO may have priority for a first frequency band of shared spectrum resources and may share one or more RUs with a second MNO that has priority for a second frequency band of the shared spectrum resources. The RU may receive a request for resources from DUs of multiple different operators, and prioritize allocation of resources based on a priority associated with an MNO of each DU. The first MNO may have a highest priority for the first frequency range of the RU and the second operator may have a lower priority for the first frequency range. The resource requests of the second MNO may be allocated for resources that are unused by the first MNO. Such techniques may allow for enhanced spectrum usage efficiency, which may enhance overall user experience for each MNO. Through prioritized resource sharing, an MNO may have priority for associated resources (e.g., time, frequency, or spatial resources), and different MNOs may be differentiated based on key performance indicators (KPIs), such as overall network latency, data rates, and the like. Thus, aspects of the present disclosure may allow spectrum regulators to enhance utilization of wireless resources while also promoting competition and innovation through KPI differences between different MNOs.

Aspects of the present disclosure may provide a handshake procedure that may be utilized for resource reservation between the DUs and the shared RUs. In some aspects, for a given resource, priority MNOs may have an opportunity to reserve its priority resources first and all unreserved resources may be allocated (e.g., allocated based on consideration) to nonpriority MNOs.

Further aspects of the present disclosure include the following:

Aspect 1 includes a method of wireless communication performed by a wireless node, the method comprising receiving, from a network node of a first network operator, a first consideration for shared spectrum resources; receiving, from a network node of a second network operator, a second consideration for the shared spectrum resources; and transmitting an indication of a resource allocation to at least one of the network node of the first network operator or the network node of the second network operator, wherein the resource allocation for the shared spectrum resources is based on the first consideration and the second consideration.

Aspect 2 includes the method of aspect 1 wherein the wireless node includes a radio unit (RU); the network node of the first network operator includes a first distributed unit (DU); and the network node of the second network operator includes a second distributed unit (DU).

Aspect 3 includes the method of any of aspects 1-2, wherein at least one of the first consideration or the second consideration comprises at least one of a token; a currency; a cryptocurrency; or a digital currency.

Aspect 4 includes the method of any of aspects 1-3, wherein the resource allocation for the shared spectrum resources is further based on at least one of a quality of service associated with communications by the first network operator in the shared spectrum resources; or a quality of service associated with communications by the second network operator in the shared spectrum resources.

Aspect 5 includes the method of any of aspects 1-4, wherein the resource allocation for the shared spectrum resources is further based on at least one of a first priority associated with the first network operator; or a second priority associated with the second network operator.

Aspect 6 includes the method of any of aspects 1-5, wherein the resource allocation for the shared spectrum resources allocates the shared spectrum resources to the network node of the first network operator.

Aspect 7 includes the method of any of aspects 1-6, wherein the resource allocation for the shared spectrum resources allocates a first portion of the shared spectrum resources to the network node of the first network operator and allocates a second portion of the shared spectrum resources to the network node of the second network operator.

Aspect 8 includes the method of any of aspects 1-7, wherein the shared spectrum resources comprise wireless resources in a time period.

Aspect 9 includes the method of any of aspects 1-8, wherein the shared spectrum resources comprise one or more frequency bands.

Aspect 10 includes the method of any of aspects 1-9, wherein the shared spectrum resources comprise wireless resources associated with a beam.

Aspect 11 includes the method of any of aspects 1-10, wherein the resource allocation for the shared spectrum resources is further based on a maximum inter-beam interference level.

Aspect 12 includes the method of any of aspects 1-11, further comprising reserving the shared spectrum resources for at least one of the network node of the first network operator or the network node of the second network operator based on the resource allocation.

Aspect 13 includes a method of wireless communication performed by a network node of a first network operator, the method comprising transmitting, to a wireless node, a first consideration for shared spectrum resources; and receiving, from the wireless node, an indication of a resource allocation associated with the shared spectrum resources, wherein the resource allocation is based on the first consideration for shared spectrum resources and a second consideration for the shared spectrum resources associated with a second network operator.

Aspect 14 includes the method of aspect 13, wherein the wireless node includes a radio unit (RU); the network node of the first network operator includes a first distributed unit (DU); and the network node of the second network operator includes a second distributed unit (DU).

Aspect 15 includes the method of any of aspects 13 or 14, wherein at least one of the first consideration or the second consideration comprises at least one of a token; a currency; a cryptocurrency; or a digital currency.

Aspect 16 includes method of any of aspects 13-15, wherein the determining the resource allocation for the shared spectrum resources further comprises determining the resource allocation based on at least one of a first priority associated with the first network operator; or a second priority associated with the second network operator.

Aspect 17 includes method of any of aspects 13-16, wherein the shared spectrum resources comprises at least one of wireless resources in a time period; one or more frequency bands; or wireless resources associated with a beam.

Aspect 18 includes a non-transitory computer-readable medium storing one or more instructions for wireless communication, the one or more instructions comprising one or more instructions that, when executed by one or more processors of a wireless node, cause the one or more processors to perform any one of aspects 1-12.

Aspect 19 includes a non-transitory computer-readable medium storing one or more instructions for wireless communication, the one or more instructions comprising one or more instructions that, when executed by one or more processors of a network node, cause the one or more processors to perform any one of aspects 13-17.

Aspect 20 includes a wireless node comprising one or more means to perform any one or more of aspects 1-12.

Aspect 21 includes a network node comprising one or more means to perform any one or more of aspects 13-17.

Aspect 22 includes a wireless node comprising a memory, a transceiver and at least one processor coupled to the memory and the transceiver, wherein the wireless node is configured to perform any one or more of aspects 1-12.

Aspect 23 includes a network node comprising a memory, a transceiver and at least one processor coupled to the memory and the transceiver, wherein the network node is configured to perform any one or more of aspects 13-17.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a wireless node, the method comprising:
receiving, from a network node of a first network operator, a first consideration for shared spectrum resources;
receiving, from a network node of a second network operator, a second consideration for the shared spectrum resources; and
transmitting an indication of a resource allocation to at least one of the network node of the first network operator or the network node of the second network operator, wherein the resource allocation for the shared spectrum resources is based on the first consideration and the second consideration.

2. The method of claim 1, wherein:
the wireless node includes a radio unit (RU);
the network node of the first network operator includes a first distributed unit (DU); and
the network node of the second network operator includes a second distributed unit (DU).

3. The method of claim 1, wherein at least one of the first consideration or the second consideration comprises at least one of:
a token;
a currency;
a cryptocurrency; or
a digital currency.

4. The method of claim 1, wherein the resource allocation for the shared spectrum resources is further based on at least one of:
a quality of service associated with communications by the first network operator in the shared spectrum resources; or
a quality of service associated with communications by the second network operator in the shared spectrum resources.

5. The method of claim 1, wherein the resource allocation for the shared spectrum resources is further based on at least one of:
a first priority associated with the first network operator; or
a second priority associated with the second network operator.

6. The method of claim 5, wherein the resource allocation for the shared spectrum resources allocates the shared spectrum resources to the network node of the first network operator.

7. The method of claim 5, wherein the resource allocation for the shared spectrum resources allocates a first portion of the shared spectrum resources to the network node of the first network operator and allocates a second portion of the shared spectrum resources to the network node of the second network operator.

8. The method of claim 1, wherein the shared spectrum resources comprise wireless resources in a time period.

9. The method of claim 1, wherein the shared spectrum resources comprise one or more frequency bands.

10. The method of claim 1, wherein the shared spectrum resources comprise wireless resources associated with a beam.

11. The method of claim 1, wherein the resource allocation for the shared spectrum resources is further based on a maximum inter-beam interference level.

12. The method of claim 1, further comprising reserving the shared spectrum resources for at least one of the network node of the first network operator or the network node of the second network operator based on the resource allocation.

13. A method of wireless communication performed by a network node of a first network operator, the method comprising:
transmitting, to a wireless node, a first consideration for shared spectrum resources; and
receiving, from the wireless node, an indication of a resource allocation associated with the shared spectrum resources, wherein the resource allocation is based on the first consideration for shared spectrum resources and a second consideration for the shared spectrum resources associated with a second network operator.

14. The method of claim 13, wherein:
the wireless node includes a radio unit (RU);
the network node of the first network operator includes a first distributed unit (DU); and
the network node of the second network operator includes a second distributed unit (DU).

15. The method of claim 13, wherein at least one of the first consideration or the second consideration comprises at least one of:
a token;
a currency;
a cryptocurrency; or
a digital currency.

16. The method of claim 13, wherein the determining the resource allocation for the shared spectrum resources further comprises determining the resource allocation based on at least one of:
a first priority associated with the first network operator; or
a second priority associated with the second network operator.

17. The method of claim 13 wherein the shared spectrum resources comprises at least one of:
wireless resources in a time period;
one or more frequency bands; or
wireless resources associated with a beam.

18. An apparatus for wireless communications at a radio unit (RU), comprising:
a processor;
memory coupled with the processor; and
instructions stored in the memory and executable by the processor to cause the apparatus to:
receive, from a network node of a first network operator, a first consideration for shared spectrum resources;
receive, from a network node of a second network operator, a second consideration for the shared spectrum resources; and
transmit an indication of a resource allocation to at least one of the network node of the first network operator or the network node of the second network operator, wherein the resource allocation for the shared spectrum resources is based on the first consideration and the second consideration.

19. The apparatus of claim 18, wherein:
the network node of the first network operator includes a first distributed unit (DU); and
the network node of the second network operator includes a second distributed unit (DU).

20. The apparatus of claim 18, wherein at least one of the first consideration or the second consideration comprises at least one of:
a token;
a currency;
a cryptocurrency; or
a digital currency.

21. The apparatus of claim 18, wherein the resource allocation for the shared spectrum resources is further based on at least one of:
a quality of service associated with communications by the first network operator in the shared spectrum resources; or
a quality of service associated with communications by the second network operator in the shared spectrum resources.

22. The apparatus of claim 18, wherein the resource allocation for the shared spectrum resources is further based on at least one of:
a first priority associated with the first network operator; or
a second priority associated with the second network operator.

23. The apparatus of claim 22, wherein the resource allocation for the shared spectrum resources allocates the shared spectrum resources to the network node of the first network operator.

24. The apparatus of claim 22, wherein the resource allocation for the shared spectrum resources allocates a first portion of the shared spectrum resources to the network node of the first network operator and allocates a second portion of the shared spectrum resources to the network node of the second network operator.

25. The apparatus of claim 18, wherein the shared spectrum resources comprise at least one of:
wireless resources in a time period;
one or more frequency bands; or
wireless resources associated with a beam.

26. The apparatus of claim 18, wherein the resource allocation for the shared spectrum resources is further based on a maximum inter-beam interference level.

27. The apparatus of claim 18, further comprising reserving the shared spectrum resources for at least one of the network node of the first network operator or the network node of the second network operator based on the resource allocation.

28. An apparatus for wireless communications at a distributed unit (DU), comprising:
a processor;
memory coupled with the processor; and
instructions stored in the memory and executable by the processor to cause the apparatus to:
transmit, to a wireless node, a first consideration for shared spectrum resources; and
receive, from the wireless node, an indication of a resource allocation associated with the shared spectrum resources, wherein the resource allocation is based on the first consideration for shared spectrum resources and a second consideration for the shared spectrum resources associated with a second network operator.

29. The apparatus of claim 28, wherein at least one of the first consideration or the second consideration comprises at least one of:
a token;
a currency;
a cryptocurrency; or
a digital currency.

30. The apparatus of claim 28, wherein the shared spectrum resources comprises at least one of:
wireless resources in a time period;
one or more frequency bands; or
wireless resources associated with a beam.
